(19) United States
(12) Patent Application Publication
(10) Pub. No.: US 2026/0365590 A1
(43) Pub. Date: Nov. 19, 2026

(54) SOLID WASTE-BASED PERMEABLE BRICK WITH HEAVY METAL/SALINE-ALKALI BARRIER AND SLOW-RELEASE FERTILIZER FUNCTIONS FOR TREE PLANTING PITS AND PREPARATION METHOD THEREOF

(71) Applicant: Inner Mongolia Agricultural University, Hohhot (CN)

(72) Inventors: Hailong WANG, Hohhot (CN); Shurong LI, Hohhot (CN); Xiaoxiao WANG, Hohhot (CN)

(73) Assignee: Inner Mongolia Agricultural University, Hohhot (CN)

(21) Appl. No.: 19/560,186

(22) Filed: Mar. 9, 2026

(30) Foreign Application Priority Data
May 13, 2025 (CN) 202510608675.2

(51) Int. Cl. C05G 5/14; C05B 1/02; C05C 3/00; C05F 3/00; C05F 5/00; C05F 7/00; C05F 11/02; C05F 17/20; C05F 17/60; C05G 3/40; C05G 5/40

(52) U.S. Cl. CPC C05G 5/14; C05B 1/02; C05C 3/005; C05F 3/00; C05F 5/002; C05F 7/005; C05F 11/02; C05F 17/20; C05F 17/60; C05G 3/40; C05G 5/40

(57) ABSTRACT

A solid waste-based permeable brick with heavy metal/saline-alkali barrier and slow-release fertilizer functions for tree planting pits includes the following components in parts by mass: 20 parts to 30 parts of a spherical-fibrous composite unit, 50 parts to 60 parts of a high-calcium sulfur-aluminum system-based multi-phase composite brick binder, 5 parts to 8 parts of a zeolite powder, 5 parts to 10 parts of calcium bentonite, 3 parts to 5 parts of a gibbsite-biochar composite material, and 40 parts to 45 parts of water. The solid waste-based permeable brick exhibits capabilities in adsorbing salt ions, blocking heavy metals, and neutralizing alkalinity. The combination of biochar with a humic acid-based substance can improve the aggregate structure of soil. The solid waste-based permeable brick overcomes the strong reliance of traditional salt-tolerant tree planting techniques on the original soil conditions.

### CROSS REFERENCE TO THE RELATED APPLICATIONS

This application is based upon and claims priority to Chinese Patent Application No. 202510608675.2, filed on May 13, 2025, the entire contents of which are incorporated herein by reference.

### TECHNICAL FIELD

The present disclosure relates to the technical field of permeable brick preparation, and specifically to a solid waste-based permeable brick with heavy metal/saline-alkali barrier and slow-release fertilizer functions for tree planting pits and a preparation method thereof.

### BACKGROUND

The Inner Mongolia Autonomous Region, as a crucial energy base in China, boasts abundant coal resources that account for one-quarter of the total coal reserves in China. The annual coal production in the Inner Mongolia Autonomous Region has consistently ranked first in China for an extended period, making a significant contribution to ensuring national energy security. However, the large-scale exploitation of mineral resources has triggered severe ecological and environmental problems. The Wuhai mining area in Inner Mongolia, a key coal-producing region and a representative mining area in Inner Mongolia, has experienced severe ecological damage due to prolonged coal mining activities. Currently, soil contamination is the most significant and direct factor severely constraining ecological restoration in large-scale ecological governance efforts.

The soil in the Wuhai mining area of the Inner Mongolia Autonomous Region has been contaminated by heavy metals (such as lead, chromium, and cadmium) due to long-term mining and industrial activities, leading to significant challenges in vegetation restoration. In recent years, during the process of ecological restoration, artificial water replenishment and the evaporation of accumulated water in mining pits have become important causes of secondary salinization. Vegetation restoration in mining areas relies on irrigation to sustain plant survival. However, under arid climate conditions, rapid evaporation of surface soil moisture causes salts from deep soil layers to accumulate toward the surface soil layer. Rainwater accumulated in mining pits resulting from open-pit mining undergoes prolonged evaporation and concentration. Consequently, salts are precipitated as crystals and diffuse into the surrounding soil, resulting in localized high-salinity patches. Some mine drainage water (dewatering effluent) typically has a high salinity and alkalinity level. If directly discharged or used to irrigate plants, such mine drainage water exacerbates soil contamination, and significantly shortens the survival period of vegetation. In some underground mining operations, high-salt mining wastewater seeps into the soil through fissures. Although the affected area is relatively limited, this phenomenon still aggravates soil salinization to some extent.

Large-scale typical mining areas in Inner Mongolia cover vast expanses with relatively shallow coal seams and inherently fragile surface ecosystems. Open-pit mining is extensively adopted for coal extraction, leading to complex soil environments. In ecological restoration efforts, improved native vegetation is introduced, such as herbaceous plants including Achnatherum splendens. However, these herbaceous plants exhibit relatively low vitality and require frequent watering and cumbersome maintenance tasks. While these herbaceous plants show no major survival issues in experimental plots, the typical lifespan of these herbaceous plants under the unique soil conditions of mining areas is only about one year, making ecological restoration exceptionally difficult. To cope with inspections or project acceptance, most companies are compelled to temporarily resort to sowing wheat seeds (Wheat seeds germinate and turn green more quickly than grass seeds, and there is low visual distinguishability between wheat seedlings and grass seedlings. As a result, a false impression of “vegetation recovery” can be created from a distance).

Under the overlay of multiple factors, ecological restoration in mining areas faces the dual challenges of heavy metal pollution and soil salinization. These two pollution factors generate a synergistic amplification effect, causing multi-dimensional damage to soil structure and function. The soil environment severely inhibits the root development of trees, resulting in a survival rate of less than 30%. Traditional remediation methods, such as soil replacement and chemical washing, have disadvantages such as high costs, susceptibility to secondary pollution, and lack of sustainability. Large-scale remediation projects are not only expensive but also less effective.

Therefore, there is an urgent need to develop a novel solid waste-based permeable brick with heavy metal/saline-alkali barrier and slow-release fertilizer functions for tree planting pits, which can provide a low-cost, long-term, and stable growth environment for tree planting in arid mining areas to significantly enhance vegetation survival rates and ecological restoration efficiency.

### SUMMARY

In view of the deficiencies of the prior art, an objective of the present disclosure is to provide a solid waste-based permeable brick with heavy metal/saline-alkali barrier and slow-release fertilizer functions for tree planting pits and a preparation method thereof. In the Wuhai mining area of the Inner Mongolia Autonomous Region, due to long-term mining and industrial activities, the soil is contaminated by heavy metals, making vegetation restoration difficult, and the arid climate exacerbates soil salinization. As a result, in the present disclosure, a spherical-fibrous composite structure is prepared as a radial flow-guiding structure from industrial solid wastes such as phosphogypsum, zeolite powder, blast furnace slag, polyaluminum chloride residue, and high-calcium fly ash and materials such as bioenzymatically hydrolyzed Broussonetia papyrifera bark and humic substances, and used to prepare a permeable brick with flow-guiding, slow release, and filtration functions. In the permeable brick, Broussonetia papyrifera bark fibers serve as flow-guiding conduits to transport harmful ions (Cd²⁺, Pb²⁺, and Cr⁶⁺) and salts in a contaminated mining area into an interior of the permeable brick for adsorption and neutralization and to release organic matters and nutrients. Through an organic-inorganic composite mechanism, the permeable brick can block heavy metal ions and reduce saline-alkali stress to promote the root growth of trees. Thus, the permeable brick can provide an efficient and sustainable metal/saline-alkali barrier effect to enhance the survival rate and growth of trees in contaminated mining areas. Traditional planting of cold-, drought-, alkali-, and pollution-resistant trees often only enables the short-term growth of trees, and cannot improve the soil environment. In contrast, the permeable brick of the present disclosure not only adsorbs salt ions but also enhances water retention, and the combination of biochar with a humic acid-based substance can improve the aggregate structure of soil. The present disclosure overcomes the strong reliance of traditional salt-tolerant tree planting techniques on the original soil conditions. Planting cold-, drought-, alkali-, and pollution-resistant trees in contaminated mining areas can stabilize the soil, prevent water and soil erosion, and reduce the spread of pollution. Moreover, vegetation cover suppresses dust, purifies the air, beautifies the environment, and rebuilds the ecosystem. The present disclosure combines low-cost remediation with potential economic benefits, and supports sustainable management and ecological restoration in mining areas.

The present disclosure employs industrial solid wastes such as phosphogypsum, zeolite powder, blast furnace slag, polyaluminum chloride residue, and high-calcium fly ash that have porous structures to physically adsorb and capture heavy metal ions. Aluminosilicates in these materials can react with heavy metals to produce stable minerals, thereby reducing the bioavailability of heavy metals. Carboxyl (—COOH) and phenolic hydroxyl (—OH) in humic acid can form chelates with heavy metals. Through the above triple-effect mechanism, heavy metals and saline-alkali components can be efficiently adsorbed.

While ensuring sufficient water permeability, the permeable brick of the present disclosure provides substantial protection for tree seedlings. As a result, drought- and alkali-resistant mature trees develop enhanced pollution resistance. In this way, although the performance of the permeable brick may decline, the intended goal is achieved. Examples of cold-, drought-, alkali-, and pollution-resistant tree species commonly found in mining areas include Elaeagnus angustifolia, Populus diversifolia, and Salix matsudana.

The research and development concept of the present disclosure is shown in FIG. 8.

To achieve the above objective, the present disclosure provides the following technical solutions:

A solid waste-based permeable brick with heavy metal/saline-alkali barrier and slow-release fertilizer functions for tree planting pits is provided, including the following components in parts by mass: 20 parts to 30 parts of a spherical-fibrous composite unit, 50 parts to 60 parts of a high-calcium sulfur-aluminum system-based multi-phase composite brick binder, 5 parts to 8 parts of a zeolite powder, 5 parts to 10 parts of calcium bentonite, 3 parts to 5 parts of a gibbsite-biochar composite material, and 40 parts to 45 parts of water.

The spherical-fibrous composite unit has a particle size of 20 mm to 30 mm, and is prepared from the following raw materials in parts by mass: 40 parts to 50 parts of phosphogypsum, 20 parts to 30 parts of blast furnace slag, 20 parts to 25 parts of polyaluminum chloride residue, 20 parts to 25 parts of waste activated sludge from a sewage treatment plant, 80 parts to 100 parts of bioenzymatically hydrolyzed Broussonetia papyrifera bark fibers, 20 parts to 23 parts of a slow-release fertilizer microgel, 10 parts to 15 parts of a glutinous rice-based bioadhesive, and 80 parts to 95 parts of water.

Preferably, the blast furnace slag has a particle size of 60 mesh to 100 mesh, and includes 30% to 48% of SiO₂, 37% to 40% of CaO, 15% to 20% of Al₂O₃, and 8% to 10% of MgO. A preparation method of the spherical-fibrous composite unit includes the following steps:
S11, adding the 40 parts to 50 parts of the phosphogypsum with a particle size of 100 mesh to 150 mesh and 50% of the 80 parts to 95 parts of the water to a mixer, and stirring for 30 s to 60 s at 100 r/min to 120 r/min; adding the 20 parts to 23 parts of the slow-release fertilizer microgel to the mixer, and further stirring for 60 s to 80 s at 80 r/min to 100 r/min; and adding the 20 parts to 30 parts of the blast furnace slag to the mixer, and further stirring for 40 s to 60 s at 60 r/min to 100 r/min;
S12, adding the 20 parts to 25 parts of the waste activated sludge from the sewage treatment plant, 18 parts to 25 parts of bioenzymatically hydrolyzed Broussonetia papyrifera bark fibers with a length of 4 mm to 10 mm, and remaining water to the mixer, and further stirring for 60 s to 120 s at 60 r/min to 80 r/min;
S13, placing a mixture obtained in the S12 into a disc granulator, and conducting spheroidization to produce a core sphere with a particle size of 20 mm to 25 mm; adding the 20 parts to 25 parts of the polyaluminum chloride residue with a particle size of 300 mesh to 350 mesh for coating with a coating thickness of 2 mm to 3 mm; slowly and evenly spray-coating the glutinous rice-based bioadhesive using a lithium-powered spray gun with a nozzle diameter of 2.2 mm and a maximum flow rate of 700 mL/min to form an adhesive layer with a thickness of 0.5 mm to 1 mm; and adding 62 parts to 75 parts of bioenzymatically hydrolyzed Broussonetia papyrifera bark fibers with a length of 45 mm to 50 mm for coating and bonding;
S14, allowing a sphere obtained in the S13 to stand at room temperature for 2 h to 3 h, and curing in a water bath at 20 °C to 23 °C for 7 d to produce the spherical-fibrous composite unit.

Preferably, the bioenzymatically hydrolyzed Broussonetia papyrifera bark fibers have lengths of 4 mm to 10 mm and 45 mm to 50 mm, respectively, and are prepared from the following raw materials in parts by mass: 2.8 parts to 12.5 parts of a cellulase, 1.4 parts to 3.7 parts of an acid protease, 0.7 part to 3.7 parts of a pectinase, and 100 parts of deionized water; the cellulase has a particle size of 100 mesh to 200 mesh, the acid protease has a particle size of 100 mesh to 200 mesh, and the pectinase has a particle size of 100 mesh to 200 mesh; and the bioenzymatically hydrolyzed Broussonetia papyrifera bark fibers are prepared through the following steps:
S111, stripping fresh Broussonetia papyrifera bark off, and drying in shade; conducting mechanical beating and rolling to preliminarily disrupt an outer cuticle structure; soaking in water for 1 d to 3 d; cutting into segments with lengths of 4 mm to 10 mm and 45 mm to 50 mm; and sterilizing resulting Broussonetia papyrifera bark fibers at 70 °C to 80 °C for 1 h;
S112, placing the 100 parts of the deionized water into a stainless steel container, and adding the 2.8 parts to 12.5 parts of the cellulase, the 1.4 parts to 3.7 parts of the acid protease, and the 0.7 part to 3.7 parts of the pectinase to the stainless steel container; heating the stainless steel container on a heating plate to a temperature of 45 °C to 50 °C, and holding the temperature of 45 °C to 50 °C for 2 min to 5 min to produce a bio-composite enzyme solution; and keeping the bio-composite enzyme solution at 45 °C to 50 °C, where during the heating, gentle stirring is conducted with a stirring rod until the three enzymes are completely dissolved;
S113, adding sterilized Broussonetia papyrifera bark fibers obtained in the S111 to the bio-composite enzyme solution obtained in the S112, and further heating the stainless steel container on the heating plate to the temperature of 45 °C to 50 °C; under heating, immersing an ultrasonic generator probe in a resulting suspension, conducting an ultrasonic treatment for 2 min to 3 min with an ultrasonic power of 100 W to 150 W and an ultrasonic frequency of 50 kHz to 60 kHz, and allowing a resulting system to stand for 20 min to 30 min; repeating the ultrasonic treatment 8 times to 10 times, with a total treatment duration of 4 h; and after enzymatic hydrolysis is completed, heating to a temperature of 85 °C, and holding the temperature of 85 °C for 10 min to allow enzyme deactivation;
S114, filtering a mixed system obtained in the S113 to produce an enzymatic hydrolysate and a solid residue, and drying the solid residue with hot air at 50 °C to 60 °C until a moisture content is less than or equal to 12% to produce the bioenzymatically hydrolyzed Broussonetia papyrifera bark fibers.

Preferably, the slow-release fertilizer microgel includes the following components in parts by mass: 2 parts to 5 parts of chitosan, 1 part to 2 parts of a glutaraldehyde crosslinking agent solution, 40 parts to 50 parts of a sheep manure fertilizer from an intensive farm, 15 parts to 20 parts of potassium humate, 8 parts to 12 parts of ammonium sulfate, 5 parts to 8 parts of calcium superphosphate, 85 parts to 90 parts of an acetic acid solution, and 30 parts to 40 parts of distilled water; and the chitosan has a particle size of 100 mesh to 200 mesh, a concentration of the glutaraldehyde crosslinking agent solution is 1% to 2%, the potassium humate has a particle size of 100 mesh to 150 mesh, the ammonium sulfate has a particle size of 60 mesh to 100 mesh, the calcium superphosphate has a particle size of 100 mesh to 200 mesh, and a concentration of the acetic acid solution is 1% to 2%.

Preferably, a preparation method of the slow-release fertilizer microgel includes the following steps:
S121, adding the 40 parts to 50 parts of the sheep manure fertilizer from the intensive farm, the 15 parts to 20 parts of the potassium humate, the 8 parts to 12 parts of the ammonium sulfate, and the 5 parts to 8 parts of the calcium superphosphate to a mixer, and stirring for 3 min to 5 min at 100 r/min to 120 r/min; and adding the 30 parts to 40 parts of the distilled water to a resulting mixed material under stirring until a humidity of the mixed material reaches 30% to 40% to produce a plastic lumpy material with a particle size of about 2 mm to 5 mm;
S122, placing the 85 parts to 90 parts of the acetic acid solution into a stainless steel container, and adding the 2 parts to 5 parts of the chitosan; and immersing an ultrasonic generator probe in a resulting solution, and conducting an ultrasonic treatment for 2 min to 3 min with an ultrasonic power of 120 W to 150 W and an ultrasonic frequency of 45 kHz to 60 kHz to make the chitosan fully dissolved and uniformly dispersed and reduce a surface tension of the solution;
S123, slowly pouring the plastic lumpy material prepared in the S121 into a chitosan solution prepared in the S122, and stirring for 5 min to 10 min with a constant-temperature magnetic stirrer at 30 °C to 35 °C and 200 r/min to 300 r/min; under stirring, adding the 1 part to 2 parts of the glutaraldehyde crosslinking agent solution dropwise at a rate of 1 drop/s to 2 drops/s; and after the dropwise addition is completed, further stirring at 200 r/min to 300 r/min for 1 min to 2 min, and allowing to stand for 2 h to 3 h, such that the chitosan undergoes crosslinking and curing on a surface of the core material to form a stable coating;
S124, pouring a solution in which the core material is coated obtained in the S123 into a centrifuge tube, centrifuging for 5 min to 8 min in a centrifuge at 3,000 r/min to 4,000 r/min, and discarding a resulting supernatant to produce slow-release fertilizer microgel particles;
S125, placing the slow-release fertilizer microgel particles obtained in the S124 into a lyophilization device, pre-cooling for 10 min to 15 min at −20 °C to 25 °C, and lyophilizing for 5 h to 8 h to produce the slow-release fertilizer microgel.

Preferably, the glutinous rice-based bioadhesive includes the following components in parts by mass: 10 parts to 15 parts of glutinous rice flour, 0.1 part to 0.2 part of alum, and 10 parts to 20 parts of water; and the glutinous rice flour has a particle size of 90 mesh to 100 mesh and the alum has a particle size of 180 mesh to 200 mesh.

Preferably, a preparation method of the glutinous rice-based bioadhesive includes the following steps:
S131, placing 5 parts to 10 parts of the water into a stainless steel container, and adding the 10 parts to 15 parts of the glutinous rice flour; and heating the stainless steel container on a heating plate to 50 °C to 60 °C, and under heating, gently stirring the mixture with a stirring rod for 3 min to 5 min;
S132, after a pasty mixture is obtained in the S131, adding the 0.1 part to 0.2 part of the alum and remaining water; further heating to 80 °C to 85 °C, and under heating, stirring the mixture with a stirring rod in an identical direction for 8 min to 10 min; and after a fluid gel-like liquid is obtained, stopping the heating, and cooling to 23 °C to 26 °C to produce the glutinous rice-based bioadhesive.

Preferably, the high-calcium sulfur-aluminum system-based multi-phase composite brick binder includes the following components in parts by mass: 40 parts to 50 parts of acidic slag powder, 25 parts to 30 parts of high-calcium fly ash, 8 parts to 12 parts of metakaolin, 4 parts to 6 parts of desulfurized gypsum, 10 parts to 12 parts of in-situ soil, and 0.1 part to 0.2 part of glycerol. The acidic slag powder includes 32.56% of SiO₂, 8.75% of Al₂O₃, and 45.11% of CaO, and has a loss on ignition of 2.3%. The high-calcium fly ash includes 30% of CaO, 41.3% of SiO₂, and 11.6% of Al₂O₃, and has a loss on ignition of 4.35%. The metakaolin includes 52.08% of SiO₂, 44.23% of Al₂O₃, and 0.52% of Fe₂O₃, and has a loss on ignition of 9.75%. The desulfurized gypsum includes 0.6% to 0.8% of P₂O₅ and 43.13% of SO₃, and has a loss on ignition of 2.29%. The in-situ soil includes 5% to 15% of NaCl and Na₂SO₄, and has a loss on ignition of 13.85%. The glycerol has a density of 1.26 g/cm³.

Preferably, a preparation method of the high-calcium sulfur-aluminum system-based multi-phase composite brick binder includes the following steps:
S21, washing the in-situ soil with water to remove soluble salts, and oven-drying in an oven at 105 °C to 110 °C for 6 h to 8 h;
S22, grinding each raw material with a ball mill until a sieve residue is less than 5% when a ground material is sieved through a 200-mesh sieve;
S23, feeding 40 parts to 50 parts of acidic slag powder, 25 parts to 30 parts of high-calcium fly ash, 8 parts to 12 parts of metakaolin, and 10 parts to 12 parts of in-situ soil into a mixer, and dry-blending for 15 min to 20 min to make the raw material powders thoroughly mixed;
S24, adding 4 parts to 5 parts of desulfurized gypsum and the 0.1 part to 0.2 part of the glycerol to a mixed powder obtained in the S23, and grinding until a specific surface area reaches 400 m²/kg to 500 m²/kg to produce the high-calcium sulfur-aluminum system-based multi-phase composite brick binder.

Preferably, the gibbsite-biochar composite material has a particle size of 30 mesh to 40 mesh, and is an aluminum- and silicon-rich porous carbon-based material produced through co-pyrolysis of gibbsite and straw biochar.

A preparation method of a solid waste-based permeable brick with heavy metal/saline-alkali barrier and slow-release fertilizer functions for tree planting pits is provided, where the preparation method is used to prepare the solid waste-based permeable brick with heavy metal/saline-alkali barrier and slow-release fertilizer functions for tree planting pits described above, and includes the following steps:
S1, adding 50 parts to 60 parts of a high-calcium sulfur-aluminum system-based multi-phase composite brick binder, 5 parts to 8 parts of a zeolite powder with a particle size of 80 mesh to 100 mesh, and 20 parts to 30 parts of a spherical-fibrous composite unit to a mixer, and premixing for 30 s to 60 s at 100 r/min to 120 r/min; and adding 5 parts to 10 parts of calcium bentonite with a particle size of 400 mesh to 500 mesh and 3 parts to 5 parts of a gibbsite-biochar composite material, and further stirring for 100 s to 160 s at 80 r/min to 100 r/min;
S2, adding 40 parts to 45 parts of water to the mixer, and stirring for 3 min to 5 min at 100 r/min to 120 r/min;
S3, spreading a resulting mixed material into a mold with dimensions of 15.5 cm×10.5 cm×5 cm, placing the mold in a press machine, and conducting vibration compaction for 10 s to 15 s at a pressure of 20 MPa and a vibration frequency of 60 Hz to 70 Hz to produce a permeable brick green body;
S4, placing the mold with the molded permeable brick green body in a curing chamber with a temperature of 20 °C to 23 °C and a relative humidity of 90% to 92%, and curing for 8 d to produce the solid waste-based permeable brick with heavy metal/saline-alkali barrier and slow-release fertilizer functions for tree planting pits, where during the curing, water is regularly sprayed to keep a surface of the permeable brick green body moist.

Compared with the prior art, the present disclosure has the following beneficial effects:
1. The spherical-fibrous composite unit of the present disclosure includes a core layer and an outer flow-guiding layer, and the two functional layers work synergistically to achieve the following triple remediation mechanism: adsorption of heavy metals, migration of salts, and enhancement of organic matter and nutrient contents to promote tree growth. The spherical-fibrous composite unit has a radial flow-guiding structure, which increases the surface area by 40% or more and enhances the pollutant contact efficiency. The core layer is a hierarchical microporous-mesoporous pore system constructed from phosphogypsum, blast furnace slag, and waste activated sludge. The core layer can achieve the capture of heavy metal ions and the migration of salt ions through a dual mechanism of physical adsorption and ion exchange. The embedded slow-release fertilizer microgel can continuously supply nutrient elements through a sustained-release action. The outer Broussonetia papyrifera bark flow-guiding layer mimics the function of plant roots. The composite bioenzyme-treated Broussonetia papyrifera bark fibers provide capillary channels to guide salts toward an interior of a sphere based on surface tension. Calcium ions in the phosphogypsum can exchange with sodium ions. Low-salinity purified water and nutrients resulting from filtration are discharged through pores of the permeable brick or seep back into roots of trees. Such a spherical-fibrous composite unit system can adsorb heavy metal ions (Cd²⁺, Pb²⁺, and Cr⁶⁺), facilitate salt migration, and effectively promote the growth of trees in heavily-contaminated saline-alkali land.
2. The Broussonetia papyrifera bark fibers exhibit a microporous hollow tubular structure with typical capillary water absorption characteristics. The high cellulose content and low lignin content in Broussonetia papyrifera bark fibers impart excellent acid and alkali resistance. The composite bioenzyme-treated Broussonetia papyrifera bark fibers provide fibrous flow-guiding conduits, which possess both mechanical support and substance transport functions and demonstrate higher flow-guiding efficiency than natural roots. The slow-release fertilizer microgel allows nutrients to be gradually decomposed and released in the soil, providing trees with balanced nutritional supply. Thus, the slow-release fertilizer microgel can enhance fertilizer utilization efficiency, reduce nitrogen volatilization and nitrate leaching, lower the risk of water eutrophication, avoid soil salinization and acidification caused by excessive fertilization, and maintain the activity of soil microorganisms. Calcium bentonite is a layer-silicate mineral with montmorillonite as a major component. Calcium bentonite exhibits strong interlayer cation exchange capacity and notable adsorption properties. The gibbsite-biochar composite material is an aluminum- and silicon-rich porous carbon-based material produced through co-pyrolysis of gibbsite (natural aluminum mineral) and straw biochar. The gibbsite-biochar composite material can promote the generation of soil aggregates and reduce the surface accumulation of salts. These different materials play a synergistic role to provide a support in various aspects including adsorption of harmful components, treatment of heavy metal pollution, migration of salts, and nutrient supply for trees.
3. Based on a solid waste resource utilization-synergistic pollutant immobilization mechanism, the high-calcium sulfur-aluminum system-based multi-phase composite brick binder provides an integrated cementitious system for the remediation of heavily-contaminated soil and the improvement of saline-alkali land in mining areas. Active silica-alumina components in acidic slag powder, high-calcium fly ash, and metakaolin can undergo pozzolanic reactions with heavy metal ions to produce stable aluminosilicate minerals. Consequently, the heavy metals are encapsulated and immobilized, which reduces the mobility and bioavailability of heavy metals. The microporous structure of desulfurized gypsum can adsorb free ions such as Na⁺ and Cl⁻ in the soil, thereby reducing the upward migration of salts to the surface. Hydration products such as ettringite and C—S—H gel can bind to soil particles to produce stable aggregates, which enhance the aeration and water retention of soil and thus promote the root development of trees.
4. Based on the synergistic design concept of solid waste-based materials, bionic structures, and ecological regulation, the permeable brick provides a composite functional system that integrates heavy metal/salt interception, water permeability, and slow nutrient release. The function implementation of the permeable brick relies on the following synergistic mechanisms: 1. Multi-stage adsorption network: Capillary effects of bionic flow-guiding channels drive a contaminated solution to pass through a coarse filtration layer and a chemical adsorption layer for stepwise purification. 2. Dynamic filtration system: Honeycomb-like permeable channels enable the discharge of purified water while simultaneously releasing slow-release micro-fertilizers. The permeable brick establishes a “salt-heavy metal-organic matter” tripartite purification pathway. The core value of the permeable brick lies in providing a low-cost and high-efficiency solution to address the challenging tree growth in heavily-contaminated soil and saline-alkali land of mining areas.

### BRIEF DESCRIPTION OF THE DRAWINGS

FIG. 1 is a schematic diagram of the preparation method of the solid waste-based permeable brick with heavy metal/saline-alkali barrier and slow-release fertilizer functions for tree planting pits in the present disclosure;

FIG. 2 is a flow chart of the preparation method of the solid waste-based permeable brick with heavy metal/saline-alkali barrier and slow-release fertilizer functions for tree planting pits in the present disclosure;

FIG. 3 is a flow chart of the preparation method of the spherical-fibrous composite unit in the present disclosure;

FIG. 4 is a flow chart of the preparation method of the bioenzymatically hydrolyzed Broussonetia papyrifera bark fibers in the present disclosure;

FIG. 5 is a flow chart of the preparation method of the slow-release fertilizer microgel in the present disclosure;

FIG. 6 is a flow chart of the preparation method of the glutinous rice-based bioadhesive in the present disclosure;

FIG. 7 is a flow chart of the preparation method of the high-calcium sulfur-aluminum system-based multi-phase composite brick binder in the present disclosure; and

FIG. 8 is a schematic diagram of the research and development concept of the present disclosure.

### DETAILED DESCRIPTION OF THE EMBODIMENTS

The present disclosure will be clearly and completely described below in conjunction with examples of the present disclosure. Obviously, the described examples are merely some rather than all of the examples of the present disclosure. All other examples obtained by those of ordinary skill in the art based on the examples of the present disclosure without creative efforts shall fall within the protection scope of the present disclosure.

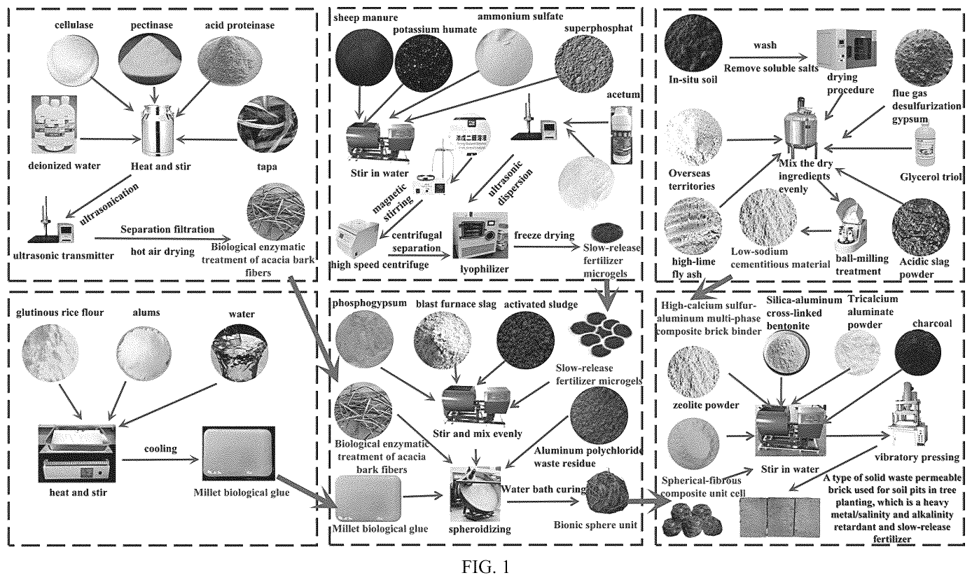

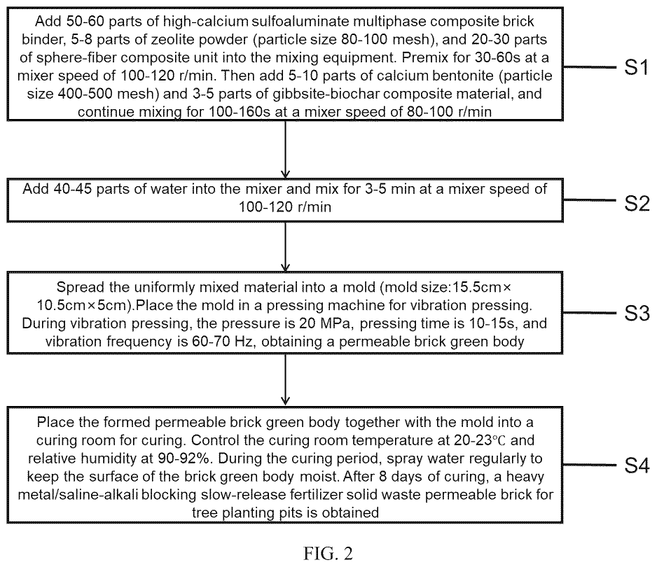

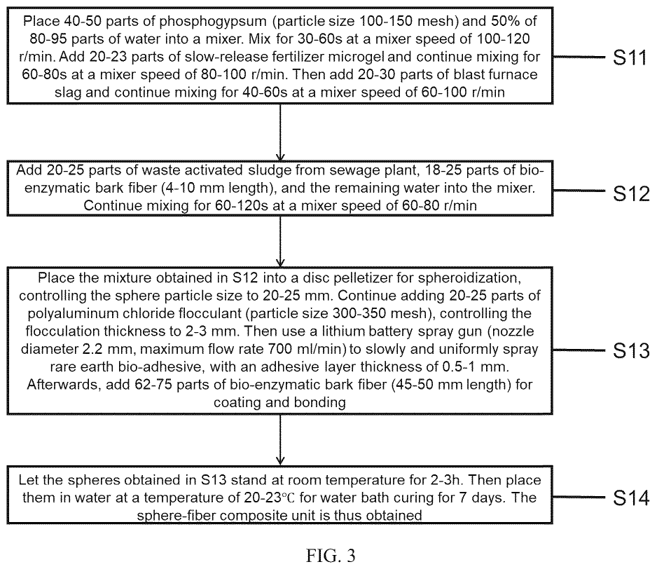

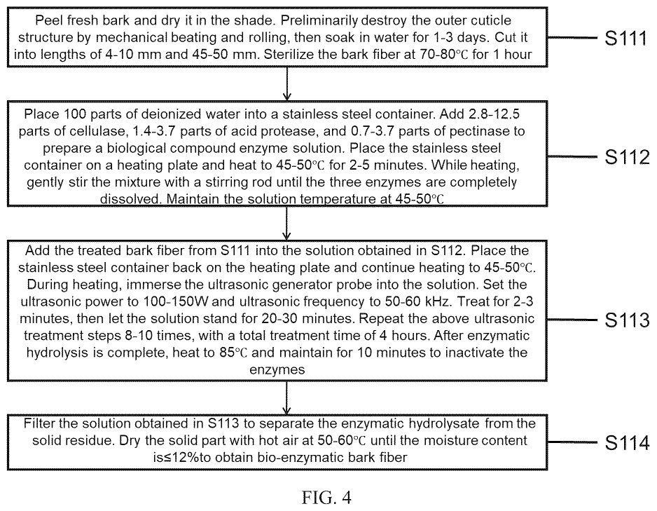

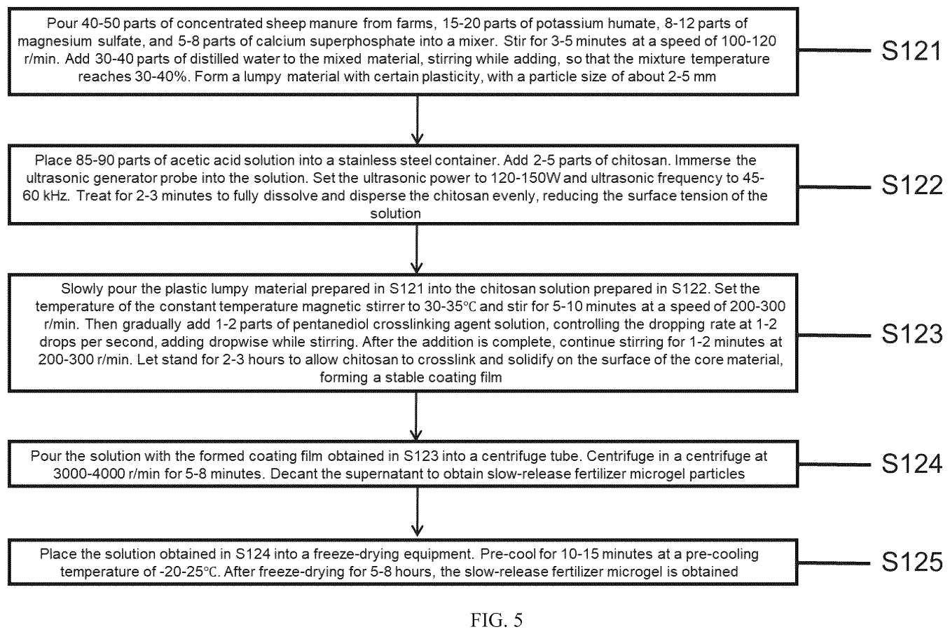

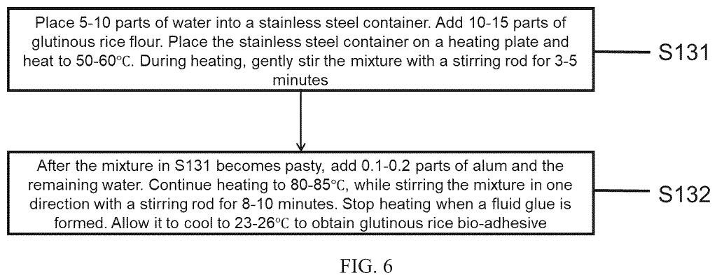

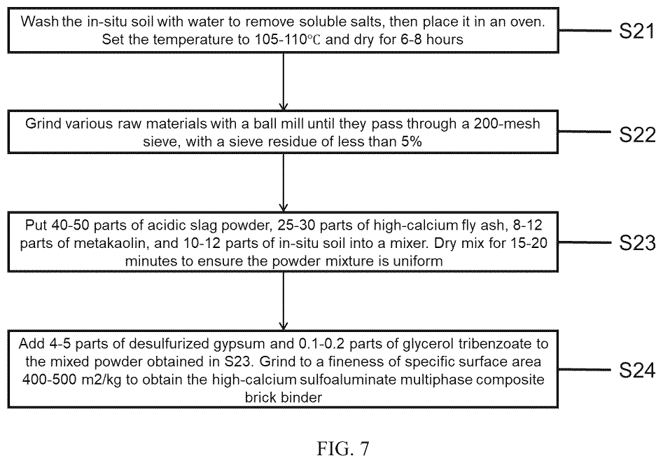

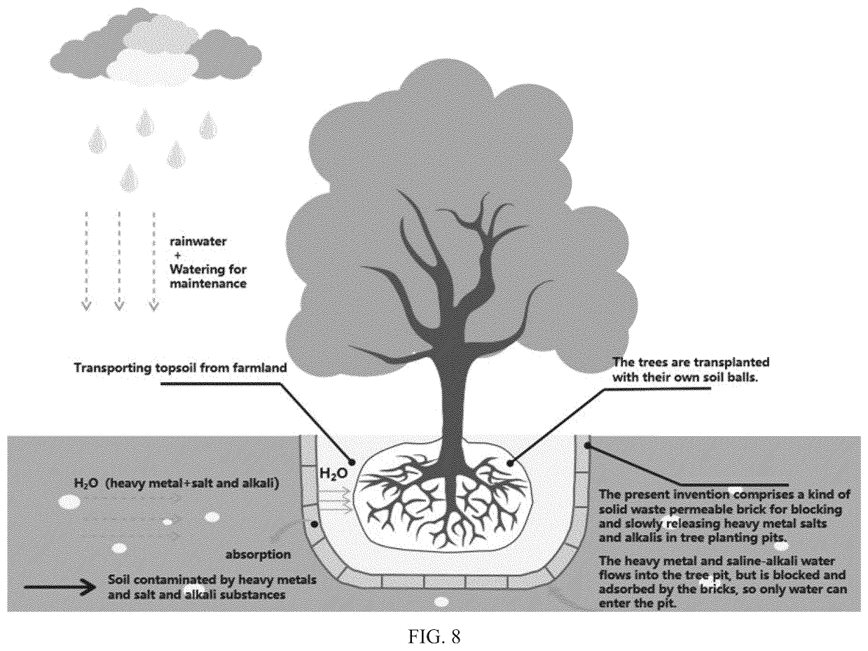

As shown in FIG. 1 to FIG. 8, the present disclosure provides the following technical solution:

In the following examples and comparative examples, waste activated sludge from a sewage treatment plant primarily refers to waste activated sludge from a municipal sewage treatment plant, and includes the following main components: microbial carriers (including microbial flocs, and inorganic particles with adsorption functions in waste activated sludge, such as sand grains and metal oxides), composite microbial communities (such as ammonia-oxidizing microorganisms, Nitrosomonas, denitrifying bacteria, nitrifying bacteria, and phosphorus-accumulating bacteria), undegraded organic matters (such as proteins and fats), and nutrient elements including nitrogen, phosphorus, potassium. Blast furnace slag has a particle size of 60 mesh to 100 mesh, and includes 30% to 48% of SiO₂, 37% to 40% of CaO, 15% to 20% of Al₂O₃, and 8% to 10% of MgO. A sheep manure fertilizer from an intensive farm has an organic matter content of 24% to 27%. Organic matters in the sheep manure fertilizer primarily originate from partially decomposed plant fibers, including cellulose, hemicellulose, lignin, and microbial metabolites. The sheep manure fertilizer can promote the generation of soil aggregates and enhance the water and nutrient retention capacity. Moreover, the sheep manure fertilizer is rich in nitrogen, phosphorus, potassium, and trace elements such as calcium, magnesium, sulfur, iron, and zinc, and includes active enzymes secreted during digestion and beneficial microorganisms (including nitrogen-fixing bacteria and cellulose-decomposing bacteria). Thus, the sheep manure fertilizer can also promote nutrient transformation and ecological balance in soil. A gibbsite-biochar composite material is produced through co-pyrolysis of gibbsite and straw biochar. Specifically, the gibbsite and the straw biochar in a mass ratio of 1:1 are pre-mixed for 30 s to 60 s in a mixer at 100 r/min to 120 r/min to produce a mixed material, and the mixed material is then subjected to co-pyrolysis for 3 h to 4 h in a muffle furnace at 400 °C to 600 °C.

### Example 1

A solid waste-based permeable brick with heavy metal/saline-alkali barrier and slow-release fertilizer functions for tree planting pits is provided. Raw materials for the solid waste-based permeable brick are shown in Table 1.

TABLE 1

| | | High-calcium | | | | |
|---|---|---|---|---|---|---|
| | | sulfur-aluminum | | | | |
| | | system-based | | | | |
| | | multi-phase | | | Gibbsite-biochar | |
| | Spherical-fibrous | composite brick | Zeolite | Calcium | composite | |
| Component | composite unit | binder | powder | bentonite | material | Water |
| Parts by | 20 | 50 | 5 | 5 | 3 | 40 |
| mass | | | | | | |

Specifically, the spherical-fibrous composite unit has a particle size of 20 mm. Raw materials for the spherical-fibrous composite unit are shown in Table 2.

TABLE 2

| | | | | Waste | | | | |
|---|---|---|---|---|---|---|---|---|
| | | | | activated | | | | |
| | | | | sludge | Bioenzymatically | | | |
| | | | | from a | hydrolyzed | | | |
| | | Blast | Polyaluminum | sewage | Broussonetia | Slow-release | Glutinous | |
| | | furnace | chloride | treatment | papyrifera | fertilizer | rice-based | |
| Component | Phosphogypsum | slag | residue | plant | bark fibers | microgel | bioadhesive | Water |
| Parts by | 40 | 20 | 20 | 20 | 80 | 20 | 10 | 80 |
| mass | | | | | | | | |

Further, the phosphogypsum has a particle size of 100 mesh.

Further, the blast furnace slag has a particle size of 60 mesh.

Further, the polyaluminum chloride residue has a particle size of 300 mesh.

Further, the bioenzymatically hydrolyzed Broussonetia papyrifera bark fibers have lengths of 4 mm and 45 mm, respectively. Raw materials for the bioenzymatically hydrolyzed Broussonetia papyrifera bark fibers are shown in Table 3.

TABLE 3

| | | | | Deionized |
|---|---|---|---|---|
| Component | Cellulase | Acid protease | Pectinase | water |
| Parts by mass | 2.8 | 1.4 | 0.7 | 100 |

Specifically, the cellulase is a grayish-white or pale-yellow powder with a particle size of 100 mesh.

Specifically, the acid protease is typically a yellowish-brown, gray, or white to pale-yellow powder with a particle size of 100 mesh.

Specifically, the pectinase is a grayish-white powder with a particle size of 100 mesh.

Further, a preparation method of the bioenzymatically hydrolyzed Broussonetia papyrifera bark fibers includes the following steps:

Step 1: Fresh Broussonetia papyrifera bark was stripped off, dried in shade, then subjected to mechanical beating or rolling to preliminarily disrupt an outer cuticle structure, soaked in water for 1 d to remove soluble impurities and soften fibers, cut into segments with lengths of 4 mm and 45 mm respectively, and then sterilized at 70 °C for 1 h to prevent microbial contamination during enzymatic hydrolysis.

Step 2: 300 g of deionized water was placed into a stainless steel container, and 8.4 g of cellulase, 4.2 g of acid protease, and 2.1 g of pectinase were added to the stainless steel container. The stainless steel container was heated on a heating plate to 45 °C and kept at 45 °C for 2 min to produce a bio-composite enzyme solution. The bio-composite enzyme solution was kept at 45 °C. During the heating, gentle stirring was conducted with a stirring rod until the three enzymes were completely dissolved.

Step 3: Sterilized Broussonetia papyrifera bark fibers obtained in the step 1 were added to the bio-composite enzyme solution obtained in the step 2, and the stainless steel container was further heated on the heating plate to 45 °C. Under heating, an ultrasonic generator probe was immersed in a resulting suspension, an ultrasonic treatment was conducted for 2 min with an ultrasonic power of 100 W and an ultrasonic frequency of 50 kHz, and a resulting system was allowed to stand for 20 min. The ultrasonic treatment operation was repeated 8 times, with a total treatment duration of 4 h to promote enzymatic hydrolysis. After the enzymatic hydrolysis was completed, heating was conducted to a temperature of 85 °C, and the temperature of 85 °C was held for 10 min to allow enzyme deactivation.

Step 4: A mixed system obtained in the step 3 was filtered to produce an enzymatic hydrolysate and a solid residue. The solid residue was dried with hot air at 50 °C until a moisture content was less than or equal to 12% to produce the bioenzymatically hydrolyzed Broussonetia papyrifera bark fibers.

Further, raw materials for the slow-release fertilizer microgel are shown in Table 4.

TABLE 4

| | | | Sheep | | | | | |
|---|---|---|---|---|---|---|---|---|
| | | | manure | | | | | |
| | | | fertilizer | | | | | |
| | | Glutaraldehyde | from an | | | | Acetic | |
| | | crosslinking | intensive | Potassium | Ammonium | Calcium | acid | Distilled |
| Component | Chitosan | agent solution | farm | humate | sulfate | superphosphate | solution | water |
| Parts by | 2 | 1 | 40 | 15 | 8 | 5 | 85 | 30 |
| mass | | | | | | | | |

Specifically, the chitosan is a powder with a particle size of 100 mesh.

Specifically, a concentration of the glutaraldehyde crosslinking agent solution is 1%.

Specifically, the potassium humate has a particle size of 100 mesh.

Specifically, the ammonium sulfate has a particle size of 60 mesh.

Specifically, the calcium superphosphate has a particle size of 100 mesh.

Specifically, a concentration of the acetic acid solution is 1%.

Further, a preparation method of the slow-release fertilizer microgel includes the following steps:

Step 1: 80 g of the sheep manure fertilizer from the intensive farm, 30 g of potassium humate, 16 g of ammonium sulfate, and 10 g of calcium superphosphate were added to a mixer and stirred at 100 r/min for 3 min to make these raw materials thoroughly mixed. 60 g of distilled water was added to a resulting mixed material under stirring until a humidity of the mixed material reached 30% to produce a plastic lumpy material with a particle size of about 2 mm.

Step 2: 170 g of the acetic acid solution was placed into a stainless steel container, and 4 g of chitosan was added. An ultrasonic generator probe was immersed in a resulting solution, and an ultrasonic treatment was conducted for 2 min with an ultrasonic power of 120 W and an ultrasonic frequency of 45 kHz to make the chitosan fully dissolved and uniformly dispersed and reduce a surface tension of the solution, which facilitated the subsequent coating operation.

Step 3: The plastic lumpy material prepared in the step 1 was slowly poured into a chitosan solution prepared in the step 2, and stirring was conducted for 5 min with a constant-temperature magnetic stirrer at 30 °C and 200 r/min to ensure that a uniform chitosan solution layer adsorbed onto a surface of the plastic lumpy material. Under stirring, 2 g of the glutaraldehyde crosslinking agent solution was added dropwise at a rate of 1 drop/s. After the dropwise addition was completed, stirring was further conducted at 200 r/min for 1 min, and a resulting mixture was allowed to stand for 2 h, such that the chitosan underwent crosslinking and curing on a surface of the core material to form a stable coating.

Step 4: After a reaction was completed, a resulting mixed solution was poured into a centrifuge tube and centrifuged for 5 min in a centrifuge at 3,000 r/min to make slow-release fertilizer microgel particles settle at a bottom of the centrifuge tube. A resulting supernatant was discarded, and the slow-release fertilizer microgel particles were retained.

Step 5: The slow-release fertilizer microgel particles obtained in the step 4 were placed into a lyophilization device, pre-cooled for 10 min at −20 °C, and lyophilized for 5 h to produce the slow-release fertilizer microgel.

Further, raw materials for the glutinous rice-based bioadhesive are shown in Table 5.

TABLE 5

| Component | Glutinous rice flour | Alum | Water |
|---|---|---|---|
| Parts by mass | 10 | 0.1 | 10 |

Specifically, the glutinous rice flour has a particle size of 90 mesh.

Specifically, the alum is a powder with a particle size of 180 mesh.

Specifically, a preparation method of the glutinous rice-based bioadhesive includes the following steps:

Step 1: 150 g of water was placed into a stainless steel container, and 300 g of glutinous rice flour was added. The stainless steel container was heated on a heating plate to 50 °C, and under heating, gentle stirring was conducted to the mixture with a stirring rod for 3 min.

Step 2: After a pasty mixture was obtained in the step 1, 3 g of alum and 150 g of water were added. Heating was further conducted to 80 °C, and under heating, stirring was conducted with a stirring rod in an identical direction for 8 min. After a fluid gel-like liquid was obtained, the heating was stopped, and cooling was conducted to 23 °C to produce the glutinous rice-based bioadhesive.

Further, a preparation method of the spherical-fibrous composite unit includes the following steps:

Step 1: 240 g of phosphogypsum and 240 g of water were added to a mixer and stirred for 30 s at 100 r/min. 120 g of the slow-release fertilizer microgel was added to the mixer, and stirring was further conducted for 60 s at 80 r/min. 120 g of blast furnace slag was added to the mixer, and stirring was further conducted for 40 s at 60 r/min.

Step 2: 120 g of the waste activated sludge, 108 g of bioenzymatically hydrolyzed Broussonetia papyrifera bark fibers with a length of 4 mm, and remaining water were added to the mixer, and stirring was further conducted for 60 s at 60 r/min.

Step 3: A mixture obtained in the step 2 was placed into a disc granulator and subjected to spheroidization to produce a core sphere with a particle size of 20 mm. 120 g of polyaluminum chloride residue was added for coating with a coating thickness of 2 mm. The glutinous rice-based bioadhesive was slowly and evenly spray-coated using a lithium-powered spray gun with a nozzle diameter of 2.2 mm and a maximum flow rate of 700 mL/min to form an adhesive layer with a thickness of 0.5 mm. 372 g of bioenzymatically hydrolyzed Broussonetia papyrifera bark fibers with a length of 45 mm were added for coating and bonding.

Step 4: A sphere obtained in the step 3 was allowed to stand at room temperature for 2 h and then cured in a water bath at 20 °C for 7 d to produce the spherical-fibrous composite unit.

Specifically, raw materials for the high-calcium sulfur-aluminum system-based multi-phase composite brick binder are shown in Table 6.

TABLE 6

| | Acidic slag | High-calcium | | Desulfurized | In-situ | |
|---|---|---|---|---|---|---|
| Component | powder | fly ash | Metakaolin | gypsum | soil | Glycerol |
| Parts by | 40 | 25 | 8 | 4 | 10 | 0.1 |
| mass | | | | | | |

Specifically, the acidic slag powder includes 32.56% of SiO₂, 8.75% of Al₂O₃, and 45.11% of CaO, and has a loss on ignition of 2.3%.

Specifically, the high-calcium fly ash includes 30% of CaO, 41.3% of SiO₂, and 11.6% of Al₂O₃, and has a loss on ignition of 4.35%.

Specifically, the metakaolin includes 52.08% of SiO₂, 44.23% of Al₂O₃, and 0.52% of Fe₂O₃, and has a loss on ignition of 9.75%.

Specifically, the desulfurized gypsum complies with the corresponding requirements in the standard GB/T 23456-2009, includes 0.6% of P₂O₅ and 43.13% of SO₃, and has a loss on ignition of 2.29%.

Specifically, the in-situ soil includes 5% of NaCl and Na₂SO₄, and has a loss on ignition of 13.85%.

Specifically, the glycerol has a density of 1.26 g/cm³.

Specifically, a role of each material is as follows: The acidic slag powder provides a silicate as an active component, and is used instead of the traditional clinker, which can reduce the alkali content. The high-calcium fly ash supplements calcium, promotes hydration reactions, and improves the pH and structure of soil. Active sites (Si—O— and Al—O—) on the surface of metakaolin adsorb heavy metals such as Pb²⁺, Cd²⁺, and Cu²⁺ through ion exchange or complexation, with a removal rate of 90% or more. The metakaolin reduces the sodium adsorption ratio (SAR) of soil through ion exchange, improves soil aggregates to enhance water permeability and aeration, and adsorbs salt ions (Na⁺ and Cl⁻) to mitigate the harmful effects of salts on crops. The desulfurized gypsum can also regulate a setting time, serve as a sulfate activator, and immobilize heavy metals. The in-situ soil is taken locally, and can reduce both the construction cost and the environmental impact. The glycerol serves as a grinding aid and an enhancer to improve grinding efficiency and fluidity.

Further, a preparation method of the high-calcium sulfur-aluminum system-based multi-phase composite brick binder includes the following steps:

Step 1: The in-situ soil was washed with water for removing soluble salts to prevent excessive Cl⁻ ions, and then oven-dried in an oven at 105 °C for 6 h.

Step 2: Each raw material was ground with a ball mill until a sieve residue was less than 5% when a ground material was sieved through a 200-mesh sieve.

Step 3: 312 g of acidic slag powder, 195 g of high-calcium fly ash, 62.4 g of metakaolin, and 78 g of in-situ soil were fed into a mixer, and dry-blended for 15 min to make the raw material powders thoroughly mixed.

Step 4: 31.2 g of desulfurized gypsum and 0.78 g of glycerol were added to a mixed powder obtained in the step 3, and grinding was conducted until a specific surface area reached 400 m²/kg to produce the high-calcium sulfur-aluminum system-based multi-phase composite brick binder.

Specifically, the spherical-fibrous composite unit has a particle size of 20 mm.

Specifically, the zeolite powder has a particle size of 80 mesh.

Specifically, the calcium bentonite has a particle size of 400 mesh.

Specifically, the gibbsite-biochar composite material has a particle size of 30 mesh.

Specifically, a preparation method of the solid waste-based permeable brick with heavy metal/saline-alkali barrier and slow-release fertilizer functions for tree planting pits includes the following steps:

Step 1: 680 g of the high-calcium sulfur-aluminum system-based multi-phase composite brick binder, 68 g of the zeolite powder, and 272 g of the spherical-fibrous composite unit were added to a mixer and premixed for 30 s at 100 r/min. 68 g of the calcium bentonite and 40.8 g of the gibbsite-biochar composite material were added, and stirring was further conducted for 100 s at 80 r/min.

Step 2: 544 g of water was added to the mixer, and stirring was conducted for 3 min at 100 r/min.

Step 3: A resulting mixed material was spread into a mold with dimensions of 15.5 cm×10.5 cm×5 cm. The mold was placed in a press machine, and vibration compaction was conducted for 10 s at a pressure of 20 MPa and a vibration frequency of 60 Hz to produce a permeable brick green body.

Step 4: The mold with the molded permeable brick green body was placed in a curing chamber with a temperature of 20 °C and a relative humidity of 90%, and curing was conducted for 8 d to produce the solid waste-based permeable brick with heavy metal/saline-alkali barrier and slow-release fertilizer functions for tree planting pits. During the curing, water was regularly sprayed to keep a surface of the permeable brick green body moist.

### Example 2

A solid waste-based permeable brick with heavy metal/saline-alkali barrier and slow-release fertilizer functions for tree planting pits is provided. Raw materials for the solid waste-based permeable brick are shown in Table 7.

TABLE 7

| | | High-calcium | | | | |
|---|---|---|---|---|---|---|
| | | sulfur-aluminum | | | | |
| | | system-based | | | | |
| | | multi-phase | | | Gibbsite-biochar | |
| | Spherical-fibrous | composite | Zeolite | Calcium | composite | |
| Component | composite unit | brick binder | powder | bentonite | material | Water |
| Parts by | 30 | 60 | 8 | 10 | 5 | 42.5 |
| mass | | | | | | |

Specifically, the spherical-fibrous composite unit has a particle size of 25 mm. Raw materials for the spherical-fibrous composite unit are shown in Table 8.

TABLE 8

| | | | | Waste | | | | |
|---|---|---|---|---|---|---|---|---|
| | | | | activated | Bioenzy | | | |
| | | | | sludge | matically | | | |
| | | | | from a | hydrolyzed | | | |
| | | Blast | Polyaluminum | sewage | Broussonetia | Slow-release | Glutinous | |
| | Phospho- | furnace | chloride | treatment | papyrifera | fertilizer | rice-based | |
| Component | gypsum | slag | residue | plant | bark fibers | microgel | bioadhesive | Water |
| Parts by | 50 | 30 | 25 | 25 | 100 | 23 | 15 | 95 |
| mass | | | | | | | | |

Further, the phosphogypsum has a particle size of 150 mesh.

Further, the blast furnace slag has a particle size of 100 mesh.

Further, the polyaluminum chloride residue has a particle size of 350 mesh.

Further, the bioenzymatically hydrolyzed Broussonetia papyrifera bark fibers have lengths of 7 mm and 47.5 mm, respectively. Raw materials for the bioenzymatically hydrolyzed Broussonetia papyrifera bark fibers are shown in Table 9.

TABLE 9

| | | | | Deionized |
|---|---|---|---|---|
| Component | Cellulase | Acid protease | Pectinase | water |
| Parts by mass | 12.5 | 3.7 | 3.7 | 100 |

Specifically, the cellulase is a grayish-white or pale-yellow powder with a particle size of 200 mesh.

Specifically, the acid protease is typically a yellowish-brown, gray, or white to pale-yellow powder with a particle size of 200 mesh.

Specifically, the pectinase is a grayish-white powder with a particle size of 200 mesh.

Further, a preparation method of the bioenzymatically hydrolyzed Broussonetia papyrifera bark fibers includes the following steps:

Step 1: Fresh Broussonetia papyrifera bark was stripped off, dried in shade, then subjected to mechanical beating or rolling to preliminarily disrupt an outer cuticle structure, soaked in water for 3 d to remove soluble impurities and soften fibers, cut into segments with lengths of 10 mm and 50 mm respectively, and then sterilized at 80 °C for 1 h to prevent microbial contamination during enzymatic hydrolysis.

Step 2: 300 g of deionized water was placed into a stainless steel container, and 37.5 g of cellulase, 11.1 g of acid protease, and 11.1 g of pectinase were added to the stainless steel container. The stainless steel container was heated on a heating plate to 50 °C and kept at 50 °C for 5 min to produce a bio-composite enzyme solution. The bio-composite enzyme solution was kept at 50 °C. During the heating, gentle stirring was conducted with a stirring rod until the three enzymes were completely dissolved.

Step 3: Sterilized Broussonetia papyrifera bark fibers obtained in the step 1 were added to the bio-composite enzyme solution obtained in the step 2, and the stainless steel container was further heated on the heating plate to 50 °C. Under heating, an ultrasonic generator probe was immersed in a resulting suspension, an ultrasonic treatment was conducted for 3 min with an ultrasonic power of 150 W and an ultrasonic frequency of 60 kHz, and a resulting system was allowed to stand for 30 min. The ultrasonic treatment operation was repeated 10 times, with a total treatment duration of 4 h to promote enzymatic hydrolysis. After the enzymatic hydrolysis was completed, heating was conducted to a temperature of 85 °C, and the temperature of 85 °C was held for 10 min to allow enzyme deactivation.

Step 4: A mixed system obtained in the step 3 was filtered to produce an enzymatic hydrolysate and a solid residue. The solid residue was dried with hot air at 60 °C until a moisture content was less than or equal to 12% to produce the bioenzymatically hydrolyzed Broussonetia papyrifera bark fibers.

Further, raw materials for the slow-release fertilizer microgel are shown in Table 10.

TABLE 10

| | | | Sheep | | | | | |
|---|---|---|---|---|---|---|---|---|
| | | | manure | | | | | |
| | | | fertilizer | | | | | |
| | | Glutaraldehyde | from an | | | | Acetic | |
| | | crosslinking | intensive | Potassium | Ammonium | Calcium | acid | Distilled |
| Component | Chitosan | agent solution | farm | humate | sulfate | superphosphate | solution | water |
| Parts by | 5 | 2 | 50 | 20 | 12 | 8 | 90 | 40 |
| mass | | | | | | | | |

Specifically, the chitosan is a powder with a particle size of 200 mesh.

Specifically, a concentration of the glutaraldehyde crosslinking agent solution is 2%.

Specifically, the potassium humate has a particle size of 150 mesh.

Specifically, the ammonium sulfate has a particle size of 100 mesh.

Specifically, the calcium superphosphate has a particle size of 200 mesh.

Specifically, a concentration of the acetic acid solution is 2%.

Further, a preparation method of the slow-release fertilizer microgel includes the following steps:

Step 1: 100 g of the sheep manure fertilizer from the intensive farm, 40 g of potassium humate, 24 g of ammonium sulfate, and 16 g of calcium superphosphate were added to a mixer and stirred at 120 r/min for 5 min to make these raw materials thoroughly mixed. 80 g of distilled water was added to a resulting mixed material under stirring until a humidity of the mixed material reached 40% to produce a plastic lumpy material with a particle size of about 5 mm.

Step 2: 180 g of the acetic acid solution was placed into a stainless steel container, and 10 g of chitosan was added. An ultrasonic generator probe was immersed in a resulting solution, and an ultrasonic treatment was conducted for 3 min with an ultrasonic power of 150 W and an ultrasonic frequency of 60 kHz to make the chitosan fully dissolved and uniformly dispersed and reduce a surface tension of the solution, which facilitated the subsequent coating operation.

Step 3: The plastic lumpy material prepared in the step 1 was slowly poured into a chitosan solution prepared in the step 2, and stirring was conducted for 10 min with a constant-temperature magnetic stirrer at 35 °C and 300 r/min to ensure that a uniform chitosan solution layer adsorbed onto a surface of the plastic lumpy material. Under stirring, 4 g of the glutaraldehyde crosslinking agent solution was added dropwise at a rate of 2 drops/s. After the dropwise addition was completed, stirring was further conducted at 300 r/min for 2 min, and a resulting mixture was allowed to stand for 3 h, such that the chitosan underwent crosslinking and curing on a surface of the core material to form a stable coating.

Step 4: After a reaction was completed, a resulting mixed solution was poured into a centrifuge tube and centrifuged for 8 min in a centrifuge at 4,000 r/min to make slow-release fertilizer microgel particles settle at a bottom of the centrifuge tube. A resulting supernatant was discarded, and the slow-release fertilizer microgel particles were retained.

Step 5: The slow-release fertilizer microgel particles obtained in the step 4 were placed into a lyophilization device, pre-cooled for 15 min at 25 °C, and lyophilized for 8 h to produce the slow-release fertilizer microgel.

Further, raw materials for the glutinous rice-based bioadhesive are shown in Table 11.

TABLE 11

| Component | Glutinous rice flour | Alum | Water |
|---|---|---|---|
| Parts by mass | 15 | 0.2 | 15 |

Specifically, the glutinous rice flour has a particle size of 100 mesh.

Specifically, the alum is a powder with a particle size of 200 mesh.

Specifically, a preparation method of the glutinous rice-based bioadhesive includes the following steps:

Step 1: 225 g of water was placed into a stainless steel container, and 450 g of glutinous rice flour was added. The stainless steel container was heated on a heating plate to 60 °C, and under heating, gentle stirring was conducted to the mixture with a stirring rod for 5 min.

Step 2: After a pasty mixture was obtained in the step 1, 6 g of alum and 225 g of water were added. Heating was further conducted to 85 °C, and under heating, stirring was conducted to the mixture with a stirring rod in an identical direction for 10 min. After a fluid gel-like liquid was obtained, the heating was stopped, and cooling was conducted to 26 °C to produce the glutinous rice-based bioadhesive.

Further, a preparation method of the spherical-fibrous composite unit includes the following steps:

Step 1: 300 g of phosphogypsum and 285 g of water were added to a mixer and stirred for 60 s at 120 r/min. 138 g of the slow-release fertilizer microgel was added to the mixer, and stirring was further conducted for 80 s at 100 r/min. 180 g of blast furnace slag was added to the mixer, and stirring was further conducted for 60 s at 100 r/min.

Step 2: 150 g of the waste activated sludge, 150 g of bioenzymatically hydrolyzed Broussonetia papyrifera bark fibers with a length of 10 mm, and remaining water were added to the mixer, and stirring was further conducted for 120 s at 80 r/min.

Step 3: A mixture obtained in the step 2 was placed into a disc granulator and subjected to spheroidization to produce a core sphere with a particle size of 25 mm. 150 g of polyaluminum chloride residue was added for coating with a coating thickness of 3 mm. The glutinous rice-based bioadhesive was slowly and evenly spray-coated using a lithium-powered spray gun with a nozzle diameter of 2.2 mm and a maximum flow rate of 700 mL/min to form an adhesive layer with a thickness of 1 mm. 450 g of bioenzymatically hydrolyzed Broussonetia papyrifera bark fibers with a length of 50 mm were added for coating and bonding.

Step 4: A sphere obtained in the step 3 was allowed to stand at room temperature for 3 h and then cured in a water bath at 23 °C for 7 d to produce the spherical-fibrous composite unit.

Specifically, raw materials for the high-calcium sulfur-aluminum system-based multi-phase composite brick binder are shown in Table 12.

TABLE 12

| | Acidic slag | High-calcium | | Desulfurized | In-situ | |
|---|---|---|---|---|---|---|
| Component | powder | fly ash | Metakaolin | gypsum | soil | Glycerol |
| Parts by | 50 | 30 | 12 | 6 | 12 | 0.2 |
| mass | | | | | | |

Specifically, the acidic slag powder includes 32.56% of SiO₂, 8.75% of Al₂O₃, and 45.11% of CaO, and has a loss on ignition of 2.3%.

Specifically, the high-calcium fly ash includes 30% of CaO, 41.3% of SiO₂, and 11.6% of Al₂O₃, and has a loss on ignition of 4.35%.

Specifically, the metakaolin includes 52.08% of SiO₂, 44.23% of Al₂O₃, and 0.52% of Fe₂O₃, and has a loss on ignition of 9.75%.

Specifically, the desulfurized gypsum complies with the corresponding requirements in the standard GB/T 23456-2009, includes 0.8% of P₂O₅ and 43.13% of SO₃, and has a loss on ignition of 2.29%.

Specifically, the in-situ soil includes 15% of NaCl and Na₂SO₄, and has a loss on ignition of 13.85%.

Specifically, the glycerol has a density of 1.26 g/cm³.

Specifically, a role of each material is as follows: The acidic slag powder provides a silicate as an active component, and is used instead of the traditional clinker, which can reduce the alkali content. The high-calcium fly ash supplements calcium, promotes hydration reactions, and improves the pH and structure of soil. Active sites (Si—O— and Al—O—) on the surface of metakaolin adsorb heavy metals such as Pb²⁺, Cd²⁺, and Cu²⁺ through ion exchange or complexation, with a removal rate of 90% or more. The metakaolin reduces the SAR of soil through ion exchange, improves soil aggregates to enhance water permeability and aeration, and adsorbs salt ions (Na⁺ and Cl⁻) to mitigate the harmful effects of salts on crops. The desulfurized gypsum can also regulate a setting time, serve as a sulfate activator, and immobilize heavy metals. The in-situ soil is taken locally, and can reduce both the construction cost and the environmental impact. The glycerol serves as a grinding aid and an enhancer to improve grinding efficiency and fluidity.

Further, a preparation method of the high-calcium sulfur-aluminum system-based multi-phase composite brick binder includes the following steps:

Step 1: The in-situ soil was washed with water for removing soluble salts to prevent excessive Cl⁻ ions, and then oven-dried in an oven at 110 °C for 8 h.

Step 2: Each raw material was ground with a ball mill until a sieve residue was less than 5% when a ground material was sieved through a 200-mesh sieve.

Step 3: 390 g of acidic slag powder, 234 g of high-calcium fly ash, 93.6 g of metakaolin, and 93.6 g of in-situ soil were fed into a mixer, and dry-blended for 20 min to make the raw material powders thoroughly mixed.

Step 4: 46.8 g of desulfurized gypsum and 1.56 g of glycerol were added to a mixed powder obtained in the step 3, and grinding was conducted until a specific surface area reached 500 m²/kg to produce the high-calcium sulfur-aluminum system-based multi-phase composite brick binder.

Specifically, the spherical-fibrous composite unit has a particle size of 30 mm.

Specifically, the zeolite powder has a particle size of 100 mesh.

Specifically, the calcium bentonite has a particle size of 500 mesh.

Specifically, the gibbsite-biochar composite material has a particle size of 40 mesh.

Specifically, a preparation method of the solid waste-based permeable brick with heavy metal/saline-alkali barrier and slow-release fertilizer functions for tree planting pits includes the following steps:

Step 1: 816 g of the high-calcium sulfur-aluminum system-based multi-phase composite brick binder, 108.8 g of the zeolite powder, and 408 g of the spherical-fibrous composite unit were added to a mixer and premixed for 60 s at 120 r/min. 136 g of the calcium bentonite and 68 g of the gibbsite-biochar composite material were added, and stirring was further conducted for 160 s at 100 r/min.

Step 2: 578 g of water was added to the mixer, and stirring was conducted for 5 min at 120 r/min.

Step 3: A resulting mixed material was spread into a mold with dimensions of 15.5 cm×10.5 cm×5 cm. The mold was placed in a press machine, and vibration compaction was conducted for 15 s at a pressure of 20 MPa and a vibration frequency of 70 Hz to produce a permeable brick green body.

Step 4: The mold with the molded permeable brick green body was placed in a curing chamber with a temperature of 23 °C and a relative humidity of 92%, and curing was conducted for 8 d to produce the solid waste-based permeable brick with heavy metal/saline-alkali barrier and slow-release fertilizer functions for tree planting pits. During the curing, water was regularly sprayed to keep a surface of the permeable brick green body moist.

### Example 3

A solid waste-based permeable brick with heavy metal/saline-alkali barrier and slow-release fertilizer functions for tree planting pits is provided. Raw materials for the solid waste-based permeable brick are shown in Table 13.

TABLE 13

| | | High-calcium | | | | |
|---|---|---|---|---|---|---|
| | | sulfur-aluminum | | | | |
| | | system-based | | | | |
| | | multi-phase | | | | |
| | Spherical-fibrous | composite | Zeolite | Calcium | Gibbsite-biochar | |
| Component | composite unit | brick binder | powder | bentonite | composite material | Water |
| Parts by | 25 | 55 | 6 | 7 | 4 | 45 |
| mass | | | | | | |

Specifically, the spherical-fibrous composite unit has a particle size of 30 mm. Raw materials for the spherical-fibrous composite unit are shown in Table 14.

TABLE 14

| | | | | Waste | | | | |
|---|---|---|---|---|---|---|---|---|
| | | | | activated | | | | |
| | | | | sludge | Bioenzymatically | | | |
| | | | | from a | hydrolyzed | | | |
| | | Blast | Polyaluminum | sewage | Broussonetia | Slow-release | Glutinous | |
| | Phospho- | furnace | chloride | treatment | papyrifera | fertilizer | rice-based | |
| Component | gypsum | slag | residue | plant | bark fibers | microgel | bioadhesive | Water |
| Parts by | 45 | 25 | 22 | 22 | 91 | 21 | 15 | 90 |
| mass | | | | | | | | |

Further, the phosphogypsum has a particle size of 120 mesh.

Further, the blast furnace slag has a particle size of 80 mesh.

Further, the polyaluminum chloride residue has a particle size of 320 mesh.

Further, the bioenzymatically hydrolyzed Broussonetia papyrifera bark fibers have lengths of 10 mm and 50 mm, respectively. Raw materials for the bioenzymatically hydrolyzed Broussonetia papyrifera bark fibers are shown in Table 15.

TABLE 15

| | | | | Deionized |
|---|---|---|---|---|
| Component | Cellulase | Acid protease | Pectinase | water |
| Parts by mass | 8 | 2.5 | 2.3 | 100 |

Specifically, the cellulase is a grayish-white or pale-yellow powder with a particle size of 150 mesh.

Specifically, the acid protease is typically a yellowish-brown, gray, or white to pale-yellow powder with a particle size of 150 mesh.

Specifically, the pectinase is a grayish-white powder with a particle size of 150 mesh.

Further, a preparation method of the bioenzymatically hydrolyzed Broussonetia papyrifera bark fibers includes the following steps:

Step 1: Fresh Broussonetia papyrifera bark was stripped off, dried in shade, then subjected to mechanical beating or rolling to preliminarily disrupt an outer cuticle structure, soaked in water for 2 d to remove soluble impurities and soften fibers, cut into segments with lengths of 8 mm and 48 mm respectively, and then sterilized at 75 °C for 1 h to prevent microbial contamination during enzymatic hydrolysis.

Step 2: 300 g of deionized water was placed into a stainless steel container, and 24 g of cellulase, 7.5 g of acid protease, and 6.9 g of pectinase were added to the stainless steel container. The stainless steel container was heated on a heating plate to 48 °C and kept at 48 °C for 3 min to produce a bio-composite enzyme solution. The bio-composite enzyme solution was kept at 48 °C. During the heating, gentle stirring was conducted with a stirring rod until the three enzymes were completely dissolved.

Step 3: Sterilized Broussonetia papyrifera bark fibers obtained in the step 1 were added to the bio-composite enzyme solution obtained in the step 2, and the stainless steel container was further heated on the heating plate to 48 °C. Under heating, an ultrasonic generator probe was immersed in a resulting suspension, an ultrasonic treatment was conducted for 2.5 min with an ultrasonic power of 120 W and an ultrasonic frequency of 55 kHz, and a resulting system was allowed to stand for 25 min. The ultrasonic treatment operation was repeated 9 times, with a total treatment duration of 4 h to promote enzymatic hydrolysis. After the enzymatic hydrolysis was completed, heating was conducted to a temperature of 85 °C, and the temperature of 85 °C was held for 10 min to allow enzyme deactivation.

Step 4: A mixed system obtained in the step 3 was filtered to produce an enzymatic hydrolysate and a solid residue. The solid residue was dried with hot air at 55 °C until a moisture content was less than or equal to 12% to produce the bioenzymatically hydrolyzed Broussonetia papyrifera bark fibers.

Further, raw materials for the slow-release fertilizer microgel are shown in Table 16.

TABLE 16

| | | | Sheep | | | | | |
|---|---|---|---|---|---|---|---|---|
| | | | manure | | | | | |
| | | | fertilizer | | | | | |
| | | Glutaraldehyde | from an | | | | Acetic | |
| | | crosslinking | intensive | Potassium | Ammonium | Calcium | acid | Distilled |
| Component | Chitosan | agent solution | farm | humate | sulfate | superphosphate | solution | water |
| Parts by | 3 | 1.5 | 45 | 18 | 10 | 6 | 88 | 35 |
| mass | | | | | | | | |

Specifically, the chitosan is a powder with a particle size of 150 mesh.

Specifically, a concentration of the glutaraldehyde crosslinking agent solution is 1.5%.

Specifically, the potassium humate has a particle size of 120 mesh.

Specifically, the ammonium sulfate has a particle size of 80 mesh.

Specifically, the calcium superphosphate has a particle size of 150 mesh.

Specifically, a concentration of the acetic acid solution is 1.5%.

Further, a preparation method of the slow-release fertilizer microgel includes the following steps:

Step 1: 90 g of the sheep manure fertilizer from the intensive farm, 36 g of potassium humate, 20 g of ammonium sulfate, and 12 g of calcium superphosphate were added to a mixer and stirred at 110 r/min for 4 min to make these raw materials thoroughly mixed. 70 g of distilled water was added to a resulting mixed material under stirring until a humidity of the mixed material reached 35% to produce a plastic lumpy material with a particle size of about 3 mm.

Step 2: 176 g of the acetic acid solution was placed into a stainless steel container, and 6 g of chitosan was added. An ultrasonic generator probe was immersed in a resulting solution, and an ultrasonic treatment was conducted for 2.5 min with an ultrasonic power of 140 W and an ultrasonic frequency of 50 kHz to make the chitosan fully dissolved and uniformly dispersed and reduce a surface tension of the solution, which facilitated the subsequent coating operation.

Step 3: The plastic lumpy material prepared in the step 1 was slowly poured into a chitosan solution prepared in the step 2, and stirring was conducted for 8 min with a constant-temperature magnetic stirrer at 32 °C and 250 r/min to ensure that a uniform chitosan solution layer adsorbed onto a surface of the plastic lumpy material. Under stirring, 3 g of the glutaraldehyde crosslinking agent solution was added dropwise at a rate of 1 drop/s. After the dropwise addition was completed, stirring was further conducted at 250 r/min for 1.5 min, and a resulting mixture was allowed to stand for 2.5 h, such that the chitosan underwent crosslinking and curing on a surface of the core material to form a stable coating.

Step 4: After a reaction was completed, a resulting mixed solution was poured into a centrifuge tube and centrifuged for 6 min in a centrifuge at 3,500 r/min to make slow-release fertilizer microgel particles settle at a bottom of the centrifuge tube. A resulting supernatant was discarded, and the slow-release fertilizer microgel particles were retained.

Step 5: The slow-release fertilizer microgel particles obtained in the step 4 were placed into a lyophilization device, pre-cooled for 12 min at 0 °C, and lyophilized for 6 h to produce the slow-release fertilizer microgel.

Further, raw materials for the glutinous rice-based bioadhesive are shown in Table 17.

TABLE 17

| Component | Glutinous rice flour | Alum | Water |
|---|---|---|---|
| Parts by mass | 12 | 0.15 | 15 |

Specifically, the glutinous rice flour has a particle size of 95 mesh.

Specifically, the alum is a powder with a particle size of 190 mesh.

Specifically, a preparation method of the glutinous rice-based bioadhesive includes the following steps:

Step 1: 225 g of water was placed into a stainless steel container, and 360 g of glutinous rice flour was added. The stainless steel container was heated on a heating plate to 55 °C, and under heating, gentle stirring was conducted to the mixture with a stirring rod for 4 min.

Step 2: After a pasty mixture was obtained in the step 1, 4.5 g of alum and 225 g of water were added. Heating was further conducted to 82 °C, and under heating, stirring was conducted to the mixture with a stirring rod in an identical direction for 9 min. After a fluid gel-like liquid was obtained, the heating was stopped, and cooling was conducted to 25 °C to produce the glutinous rice-based bioadhesive.

Further, a preparation method of the spherical-fibrous composite unit includes the following steps:

Step 1: 270 g of phosphogypsum and 270 g of water were added to a mixer and stirred for 45 s at 110 r/min. 126 g of the slow-release fertilizer microgel was added to the mixer, and stirring was further conducted for 70 s at 90 r/min. 150 g of blast furnace slag was added to the mixer, and stirring was further conducted for 50 s at 80 r/min.

Step 2: 132 g of the waste activated sludge, 126 g of bioenzymatically hydrolyzed Broussonetia papyrifera bark fibers with a length of 8 mm, and remaining water were added to the mixer, and stirring was further conducted for 100 s at 70 r/min.

Step 3: A mixture obtained in the step 2 was placed into a disc granulator and subjected to spheroidization to produce a core sphere with a particle size of 22 mm. 132 g of polyaluminum chloride residue was added for coating with a coating thickness of 2.5 mm. The glutinous rice-based bioadhesive was slowly and evenly spray-coated using a lithium-powered spray gun with a nozzle diameter of 2.2 mm and a maximum flow rate of 700 mL/min to form an adhesive layer with a thickness of 0.7 mm. 420 g of bioenzymatically hydrolyzed Broussonetia papyrifera bark fibers with a length of 47 mm were added for coating and bonding.

Step 4: A sphere obtained in the step 3 was allowed to stand at room temperature for 2.5 h and then cured in a water bath at 21 °C for 7 d to produce the spherical-fibrous composite unit.

Specifically, raw materials for the high-calcium sulfur-aluminum system-based multi-phase composite brick binder are shown in Table 18.

TABLE 18

| | Acidic slag | High-calcium | | Desulfurized | In-situ | |
|---|---|---|---|---|---|---|
| Component | powder | fly ash | Metakaolin | gypsum | soil | Glycerol |
| Parts by | 45 | 27 | 10 | 4.5 | 11 | 0.15 |
| mass | | | | | | |

Specifically, the acidic slag powder includes 32.56% of SiO₂, 8.75% of Al₂O₃, and 45.11% of CaO, and has a loss on ignition of 2.3%.

Specifically, the high-calcium fly ash includes 30% of CaO, 41.3% of SiO₂, and 11.6% of Al₂O₃, and has a loss on ignition of 4.35%.

Specifically, the metakaolin includes 52.08% of SiO₂, 44.23% of Al₂O₃, and 0.52% of Fe₂O₃, and has a loss on ignition of 9.75%.

Specifically, the desulfurized gypsum complies with the corresponding requirements in the standard GB/T 23456-2009, includes 0.7% of P₂O₅ and 43.13% of SO₃, and has a loss on ignition of 2.29%.

Specifically, the in-situ soil includes 10% of NaCl and Na₂SO₄, and has a loss on ignition of 13.85%.

Specifically, the glycerol has a density of 1.26 g/cm³.

Specifically, a role of each material is as follows: The acidic slag powder provides a silicate as an active component, and is used instead of the traditional clinker, which can reduce the alkali content. The high-calcium fly ash supplements calcium, promotes hydration reactions, and improves the pH and structure of soil. Active sites (Si—O— and Al—O—) on the surface of metakaolin adsorb heavy metals such as Pb²⁺, Cd²⁺, and Cu²⁺ through ion exchange or complexation, with a removal rate of 90% or more. The metakaolin reduces the SAR of soil through ion exchange, improves soil aggregates to enhance water permeability and aeration, and adsorbs salt ions (Na⁺ and Cl⁻) to mitigate the harmful effects of salts on crops. The desulfurized gypsum can also regulate a setting time, serve as a sulfate activator, and immobilize heavy metals. The in-situ soil is taken locally, and can reduce both the construction cost and the environmental impact. The glycerol serves as a grinding aid and an enhancer to improve grinding efficiency and fluidity. Further, a preparation method of the high-calcium sulfur-aluminum system-based multi-phase composite brick binder includes the following steps:

Step 1: The in-situ soil was washed with water for removing soluble salts to prevent excessive Cl⁻ ions, and then oven-dried in an oven at 107 °C for 7 h.

Step 2: Each raw material was ground with a ball mill until a sieve residue was less than 5% when a ground material was sieved through a 200-mesh sieve.

Step 3: 351 g of acidic slag powder, 210.6 g of high-calcium fly ash, 78 g of metakaolin, and 85.8 g of in-situ soil were fed into a mixer, and dry-blended for 17 min to make the raw material powders thoroughly mixed.

Step 4: 35.1 g of desulfurized gypsum and 1.17 g of glycerol were added to a mixed powder obtained in the step 3, and grinding was conducted until a specific surface area reached 450 m²/kg to produce the high-calcium sulfur-aluminum system-based multi-phase composite brick binder.

Specifically, the spherical-fibrous composite unit has a particle size of 25 mm.

Specifically, the zeolite powder has a particle size of 90 mesh.

Specifically, the calcium bentonite has a particle size of 450 mesh.

Specifically, the gibbsite-biochar composite material has a particle size of 35 mesh.

Specifically, a preparation method of the solid waste-based permeable brick with heavy metal/saline-alkali barrier and slow-release fertilizer functions for tree planting pits includes the following steps:

Step 1: 748 g of the high-calcium sulfur-aluminum system-based multi-phase composite brick binder, 81.6 g of the zeolite powder, and 340 g of the spherical-fibrous composite unit were added to a mixer and premixed for 40 s at 110 r/min. 95.2 g of the calcium bentonite and 54.4 g of the gibbsite-biochar composite material were added, and stirring was further conducted for 130 s at 90 r/min.

Step 2: 612 g of water was added to the mixer, and stirring was conducted for 4 min at 110 r/min.

Step 3: A resulting mixed material was spread into a mold with dimensions of 15.5 cm×10.5 cm×5 cm. The mold was placed in a press machine, and vibration compaction was conducted for 12 s at a pressure of 20 MPa and a vibration frequency of 65 Hz to produce a permeable brick green body.

Step 4: The mold with the molded permeable brick green body was placed in a curing chamber with a temperature of 21 °C and a relative humidity of 91%, and curing was conducted for 8 d to produce the solid waste-based permeable brick with heavy metal/saline-alkali barrier and slow-release fertilizer functions for tree planting pits. During the curing, water was regularly sprayed to keep a surface of the permeable brick green body moist.

### COMPARATIVE EXAMPLES

Comparative Example 1: Comparative Example 1 is different from Example 1 merely in that, in Comparative Example 1, the bioenzymatically hydrolyzed Broussonetia papyrifera bark fibers in the spherical-fibrous composite unit are omitted, and grass fibers in equal parts by mass are used instead.

Comparative Example 2: Comparative Example 2 is different from Example 2 merely in that, in Comparative Example 2, the bioenzymatically hydrolyzed Broussonetia papyrifera bark fibers in the spherical-fibrous composite unit are omitted, and maize straw fibers in equal parts by mass are used instead.

Comparative Example 3: Comparative Example 3 is different from Example 3 merely in that, in Comparative Example 3, the slow-release fertilizer microgel in the spherical-fibrous composite unit is omitted, and the sheep manure fertilizer, potassium humate, ammonium sulfate, and calcium superphosphate in equal parts by mass are used instead.

### Performance Testing:

Saplings used for the aforementioned examples and comparative examples are all Elaeagnus angustifolia. Elaeagnus angustifolia is the city tree of Wuhai, and exhibits exceptional drought tolerance, saline-alkali resistance, ability to thrive in poor soils, and strong wind-sand resistance. With a well-developed root system, Elaeagnus angustifolia can grow in an arid environment with an annual precipitation as low as 160 mm, and exhibits strong adaptability to saline-alkali soil. However, although Elaeagnus angustifolia saplings are salt-tolerant, Elaeagnus angustifolia saplings cannot withstand heavy metal contamination in mining areas, resulting in low survival rates. The solid waste-based permeable bricks with heavy metal/saline-alkali barrier and slow-release fertilizer functions for tree planting pits prepared in Examples 1 to 3 and Comparative Examples 1 to 3 were each tested for a water permeability coefficient, a heavy metal interception rate, a pH value, a salt content, and a tree survival rate. Test results are shown in Table 19.

TABLE 19
Water permeability coefficients, heavy metal (Cd²⁺, Pb²⁺, and Cr⁶⁺) interception
rates, pH values, salt contents, and tree survival rates of the solid waste-based permeable
bricks with heavy metal/saline-alkali barrier and slow-release fertilizer functions
for tree planting pits prepared in Examples 1 to 3 and Comparative Examples 1 to 3

| | Water | Cd²⁺ | Pb²⁺ | Cr⁶⁺ | | | Three-month | Six-month |
|---|---|---|---|---|---|---|---|---|
| | permeability | interception | interception | interception | | Salt | tree | tree |
| | coefficient | rate | rate | rate | pH | content | survival | survival |
| | (cm/s) | (%) | (%) | (%) | value | (%) | rate (%) | rate (%) |
| Example 1 | 2.48 × 10⁻² | 80 | 84 | 86 | 8.2 | 0.34 | 94 | 90 |
| Example 2 | 2.81 × 10⁻² | 83 | 87 | 84 | 7.8 | 0.31 | 97 | 95 |
| Example 3 | 2.76 × 10⁻² | 85 | 88 | 86 | 8.3 | 0.35 | 95 | 89 |
| Comparative | 2.43 × 10⁻² | 70 | 72 | 70 | 8.7 | 0.41 | 91 | 80 |
| Example 1 | | | | | | | | |
| Comparative | 2.75 × 10⁻² | 72 | 74 | 75 | 8.5 | 0.39 | 90 | 76 |
| Example 2 | | | | | | | | |
| Comparative | 2.76 × 10⁻² | 84 | 87 | 88 | 8.3 | 0.35 | 88 | 67 |
| Example 3 | | | | | | | | |
| Blank | — | — | — | — | 9.1 | 0.47 | 53 | 38 |
| control | | | | | | | | |
| group | | | | | | | | |

With tree survival rates as an example, a difference in the six-month tree survival rate can be as high as 28%. This strongly proves that the solid waste-based permeable brick with heavy metal/saline-alkali barrier and slow-release fertilizer functions for tree planting pits prepared in the present disclosure effectively consumes large amounts of solid wastes that reduce the cost, and can significantly improve the survival rate of trees in heavy metal-contaminated saline-alkali soil, effectively mitigate saline-alkali stress, and reduce contamination from heavy metal ions.

Although the embodiments of the present disclosure have been illustrated and described, it should be understood by a person of ordinary skill in the art that various changes, modifications, replacements, and variations may be made to the embodiments without departing from the principle and spirit of the present disclosure. The scope of the present disclosure is subject to the appended claims and equivalents thereof.

What is claimed is:

1. A solid waste-based permeable brick with heavy metal/saline-alkali barrier and slow-release fertilizer functions for tree planting pits, comprising the following components in parts by mass: 20 parts to 30 parts of a spherical-fibrous composite unit, 50 parts to 60 parts of a high-calcium sulfur-aluminum system-based multi-phase composite brick binder, 5 parts to 8 parts of a zeolite powder, 5 parts to 10 parts of calcium bentonite, 3 parts to 5 parts of a gibbsite-biochar composite material, and 40 parts to 45 parts of water,
wherein the spherical-fibrous composite unit has a particle size of 20 mm to 30 mm, and is prepared from the following raw materials in parts by mass: 40 parts to 50 parts of phosphogypsum, 20 parts to 30 parts of blast furnace slag, 20 parts to 25 parts of polyaluminum chloride residue, 20 parts to 25 parts of waste activated sludge from a sewage treatment plant, 80 parts to 100 parts of bioenzymatically hydrolyzed Broussonetia papyrifera bark fibers, 20 parts to 23 parts of a slow-release fertilizer microgel, 10 parts to 15 parts of a glutinous rice-based bioadhesive, and 80 parts to 95 parts of the water;
a preparation method of the spherical-fibrous composite unit comprises the following steps:
S11, adding the 40 parts to 50 parts of the phosphogypsum with a particle size of 100 mesh to 150 mesh and 50% of the 80 parts to 95 parts of the water to a mixer, and stirring for 30 s to 60 s at 100 r/min to 120 r/min; adding the 20 parts to 23 parts of the slow-release fertilizer microgel to the mixer, and further stirring for 60 s to 80 s at 80 r/min to 100 r/min; and adding the 20 parts to 30 parts of the blast furnace slag to the mixer, and further stirring for 40 s to 60 s at 60 r/min to 100 r/min;
S12, adding the 20 parts to 25 parts of the waste activated sludge from the sewage treatment plant, 18 parts to 25 parts of bioenzymatically hydrolyzed Broussonetia papyrifera bark fibers with a length of 4 mm to 10 mm, and remaining water to the mixer, and further stirring for 60 s to 120 s at 60 r/min to 80 r/min;
S13, placing a mixture obtained in the S12 into a disc granulator, and conducting spheroidization to produce a core sphere with a particle size of 20 mm to 25 mm; adding the 20 parts to 25 parts of the polyaluminum chloride residue with a particle size of 300 mesh to 350 mesh for coating with a coating thickness of 2 mm to 3 mm; slowly and evenly spray-coating the glutinous rice-based bioadhesive using a lithium-powered spray gun with a nozzle diameter of 2.2 mm and a maximum flow rate of 700 mL/min to form an adhesive layer with a thickness of 0.5 mm to 1 mm; and adding 62 parts to 75 parts of bioenzymatically hydrolyzed Broussonetia papyrifera bark fibers with a length of 45 mm to 50 mm for coating and bonding;
S14, allowing a sphere obtained in the S13 to stand at room temperature for 2 h to 3 h, and curing in a water bath at 20 °C to 23 °C for 7 d to produce the spherical-fibrous composite unit.

2. The solid waste-based permeable brick with the heavy metal/saline-alkali barrier and slow-release fertilizer functions for the tree planting pits according to claim 1, wherein the bioenzymatically hydrolyzed Broussonetia papyrifera bark fibers have lengths of 4 mm to 10 mm and 45 mm to 50 mm, respectively, and are prepared from the following raw materials in parts by mass: 2.8 parts to 12.5 parts of a cellulase, 1.4 parts to 3.7 parts of an acid protease, 0.7 part to 3.7 parts of a pectinase, and 100 parts of deionized water; the cellulase has a particle size of 100 mesh to 200 mesh, the acid protease has a particle size of 100 mesh to 200 mesh, and the pectinase has a particle size of 100 mesh to 200 mesh; and the bioenzymatically hydrolyzed Broussonetia papyrifera bark fibers are prepared through the following steps:
S111, stripping fresh Broussonetia papyrifera bark off, and drying in shade; conducting mechanical beating and rolling to preliminarily disrupt an outer cuticle structure; soaking in the water for 1 d to 3 d; cutting into segments with the lengths of 4 mm to 10 mm and 45 mm to 50 mm; and sterilizing resulting Broussonetia papyrifera bark fibers at 70 °C to 80 °C for 1 h;
S112, placing the 100 parts of the deionized water into a stainless steel container, and adding the 2.8 parts to 12.5 parts of the cellulase, the 1.4 parts to 3.7 parts of the acid protease, and the 0.7 part to 3.7 parts of the pectinase to the stainless steel container; heating the stainless steel container on a heating plate to a temperature of 45 °C to 50 °C, and holding the temperature of 45 °C to 50 °C for 2 min to 5 min to produce a bio-composite enzyme solution; and keeping the bio-composite enzyme solution at 45 °C to 50 °C, wherein during the heating, gentle stirring is conducted with a stirring rod until three enzymes are completely dissolved;
S113, adding sterilized Broussonetia papyrifera bark fibers obtained in the S111 to the bio-composite enzyme solution obtained in the S112, and further heating the stainless steel container on the heating plate to the temperature of 45 °C to 50 °C; under heating, immersing an ultrasonic generator probe in a resulting suspension, conducting an ultrasonic treatment for 2 min to 3 min with an ultrasonic power of 100 W to 150 W and an ultrasonic frequency of 50 kHz to 60 kHz, and allowing a resulting system to stand for 20 min to 30 min; repeating the ultrasonic treatment 8 times to 10 times, with a total treatment duration of 4 h; and after enzymatic hydrolysis is completed, heating to a temperature of 85 °C, and holding the temperature of 85 °C for 10 min to allow enzyme deactivation;
S114, filtering a mixed system obtained in the S113 to produce an enzymatic hydrolysate and a solid residue, and drying the solid residue with hot air at 50 °C to 60 °C until a moisture content is less than or equal to 12% to produce the bioenzymatically hydrolyzed Broussonetia papyrifera bark fibers.

3. The solid waste-based permeable brick with the heavy metal/saline-alkali barrier and slow-release fertilizer functions for the tree planting pits according to claim 1, wherein the slow-release fertilizer microgel comprises the following components in parts by mass: 2 parts to 5 parts of chitosan, 1 part to 2 parts of a glutaraldehyde crosslinking agent solution, 40 parts to 50 parts of a sheep manure fertilizer from an intensive farm, 15 parts to 20 parts of potassium humate, 8 parts to 12 parts of ammonium sulfate, 5 parts to 8 parts of calcium superphosphate, 85 parts to 90 parts of an acetic acid solution, and 30 parts to 40 parts of distilled water; and the chitosan has a particle size of 100 mesh to 200 mesh, a concentration of the glutaraldehyde crosslinking agent solution is 1% to 2%, the potassium humate has a particle size of 100 mesh to 150 mesh, the ammonium sulfate has a particle size of 60 mesh to 100 mesh, the calcium superphosphate has a particle size of 100 mesh to 200 mesh, and a concentration of the acetic acid solution is 1% to 2%.

4. The solid waste-based permeable brick with the heavy metal/saline-alkali barrier and slow-release fertilizer functions for the tree planting pits according to claim 3, wherein a preparation method of the slow-release fertilizer microgel comprises the following steps:
S121, adding the 40 parts to 50 parts of the sheep manure fertilizer from the intensive farm, the 15 parts to 20 parts of the potassium humate, the 8 parts to 12 parts of the ammonium sulfate, and the 5 parts to 8 parts of the calcium superphosphate to a mixer, and stirring for 3 min to 5 min at 100 r/min to 120 r/min; and adding the 30 parts to 40 parts of the distilled water to a resulting mixed material under stirring until a humidity of the mixed material reaches 30% to 40% to produce a plastic lumpy material with a particle size of 2 mm to 5 mm;
S122, placing the 85 parts to 90 parts of the acetic acid solution into a stainless steel container, and adding the 2 parts to 5 parts of the chitosan; and immersing an ultrasonic generator probe in a resulting solution, and conducting an ultrasonic treatment for 2 min to 3 min with an ultrasonic power of 120 W to 150 W and an ultrasonic frequency of 45 kHz to 60 kHz to make the chitosan fully dissolved and uniformly dispersed and reduce a surface tension of the solution;
S123, slowly pouring the plastic lumpy material prepared in the S121 into a chitosan solution prepared in the S122, and stirring for 5 min to 10 min with a constant-temperature magnetic stirrer at 30 °C to 35 °C and 200 r/min to 300 r/min; under stirring, adding the 1 part to 2 parts of the glutaraldehyde crosslinking agent solution dropwise at a rate of 1 drop/s to 2 drops/s; and after dropwise addition is completed, further stirring at 200 r/min to 300 r/min for 1 min to 2 min, and allowing to stand for 2 h to 3 h, such that the chitosan undergoes crosslinking and curing on a surface of a core material to form a stable coating;
S124, pouring a solution in which the core material is coated obtained in the S123 into a centrifuge tube, centrifuging for 5 min to 8 min in a centrifuge at 3,000 r/min to 4,000 r/min, and discarding a resulting supernatant to produce slow-release fertilizer microgel particles;
S125, placing the solution obtained in the S124 into a lyophilization device, pre-cooling for 10 min to 15 min at −20 °C, and lyophilizing for 5 h to 8 h to produce the slow-release fertilizer microgel.

5. The solid waste-based permeable brick with the heavy metal/saline-alkali barrier and slow-release fertilizer functions for the tree planting pits according to claim 1, wherein the glutinous rice-based bioadhesive comprises the following components in parts by mass: 10 parts to 15 parts of glutinous rice flour, 0.1 part to 0.2 part of alum, and 10 parts to 20 parts of the water; and the glutinous rice flour has a particle size of 90 mesh to 100 mesh, and the alum has a particle size of 180 mesh to 200 mesh.

6. The solid waste-based permeable brick with the heavy metal/saline-alkali barrier and slow-release fertilizer functions for the tree planting pits according to claim 5, wherein a preparation method of the glutinous rice-based bioadhesive comprises the following steps:
S131, placing 5 parts to 10 parts of the water into a stainless steel container, and adding the 10 parts to 15 parts of the glutinous rice flour; and heating the stainless steel container on a heating plate to 50 °C to 60 °C, and under heating, gently stirring a mixture with a stirring rod for 3 min to 5 min;
S132, after a pasty mixture is obtained in the S131, adding the 0.1 part to 0.2 part of the alum and remaining water; further heating to 80 °C to 85 °C, and under heating, stirring a mixture with a stirring rod in an identical direction for 8 min to 10 min; and after a fluid gel-like liquid is obtained, stopping the heating, and cooling to 23 °C to 26 °C to produce the glutinous rice-based bioadhesive.

7. The solid waste-based permeable brick with the heavy metal/saline-alkali barrier and slow-release fertilizer functions for the tree planting pits according to claim 1, wherein the high-calcium sulfur-aluminum system-based multi-phase composite brick binder comprises the following components in parts by mass: 40 parts to 50 parts of acidic slag powder, 25 parts to 30 parts of high-calcium fly ash, 8 parts to 12 parts of metakaolin, 4 parts to 6 parts of desulfurized gypsum, 10 parts to 12 parts of in-situ soil, and 0.1 part to 0.2 part of glycerol; and a preparation method of the high-calcium sulfur-aluminum system-based multi-phase composite brick binder comprises the following steps:
S21, washing the in-situ soil with the water to remove soluble salts, and oven-drying in an oven at 105 °C to 110 °C for 6 h to 8 h;
S22, grinding each raw material with a ball mill until a sieve residue is less than 5% when a ground material is sieved through a 200-mesh sieve;
S23, feeding the 40 parts to 50 parts of acidic slag powder, the 25 parts to 30 parts of high-calcium fly ash, the 8 parts to 12 parts of metakaolin, and the 10 parts to 12 parts of in-situ soil into a mixer, and dry-blending for 15 min to 20 min to make raw material powders thoroughly mixed;
S24, adding the 4 parts to 6 parts of the desulfurized gypsum and the 0.1 part to 0.2 part of the glycerol to a mixed powder obtained in the S23, and grinding until a specific surface area reaches 400 m²/kg to 500 m²/kg to produce the high-calcium sulfur-aluminum system-based multi-phase composite brick binder.

8. The solid waste-based permeable brick with the heavy metal/saline-alkali barrier and slow-release fertilizer functions for the tree planting pits according to claim 1, wherein the gibbsite-biochar composite material has a particle size of 30 mesh to 40 mesh, and is an aluminum- and silicon-rich porous carbon-based material produced through co-pyrolysis of gibbsite and straw biochar.

9. A preparation method of a solid waste-based permeable brick with heavy metal/saline-alkali barrier and slow-release fertilizer functions for tree planting pits, wherein the preparation method is used to prepare the solid waste-based permeable brick with the heavy metal/saline-alkali barrier and slow-release fertilizer functions for the tree planting pits according to claim 1, and comprises the following steps:
S1, adding the 50 parts to 60 parts of the high-calcium sulfur-aluminum system-based multi-phase composite brick binder, the 5 parts to 8 parts of the zeolite powder with a particle size of 80 mesh to 100 mesh, and the 20 parts to 30 parts of the spherical-fibrous composite unit to a mixer, and premixing for 30 s to 60 s at 100 r/min to 120 r/min; and adding the 5 parts to 10 parts of the calcium bentonite with a particle size of 400 mesh to 500 mesh and the 3 parts to 5 parts of the gibbsite-biochar composite material, and further stirring for 100 s to 160 s at 80 r/min to 100 r/min;
S2, adding the 40 parts to 45 parts of the water to the mixer, and stirring for 3 min to 5 min at 100 r/min to 120 r/min;
S3, spreading a resulting mixed material into a mold with dimensions of 15.5 cm×10.5 cm×5 cm, placing the mold in a press machine, and conducting vibration compaction for 10 s to 15 s at a pressure of 20 MPa and a vibration frequency of 60 Hz to 70 Hz to produce a permeable brick green body;
S4, placing the mold with a molded permeable brick green body in a curing chamber with a temperature of 20 °C to 23 °C and a relative humidity of 90% to 92%, and curing for 8 d to produce the solid waste-based permeable brick with the heavy metal/saline-alkali barrier and slow-release fertilizer functions for the tree planting pits, wherein during the curing, the water is regularly sprayed to keep a surface of the permeable brick green body moist.

10. The preparation method according to claim 9, wherein in the solid waste-based permeable brick with the heavy metal/saline-alkali barrier and slow-release fertilizer functions for the tree planting pits, the bioenzymatically hydrolyzed Broussonetia papyrifera bark fibers have lengths of 4 mm to 10 mm and 45 mm to 50 mm, respectively, and are prepared from the following raw materials in parts by mass: 2.8 parts to 12.5 parts of a cellulase, 1.4 parts to 3.7 parts of an acid protease, 0.7 part to 3.7 parts of a pectinase, and 100 parts of deionized water;
the cellulase has a particle size of 100 mesh to 200 mesh, the acid protease has a particle size of 100 mesh to 200 mesh, and the pectinase has a particle size of 100 mesh to 200 mesh; and the bioenzymatically hydrolyzed Broussonetia papyrifera bark fibers are prepared through the following steps:
S111, stripping fresh Broussonetia papyrifera bark off, and drying in shade; conducting mechanical beating and rolling to preliminarily disrupt an outer cuticle structure; soaking in the water for 1 d to 3 d; cutting into segments with the lengths of 4 mm to 10 mm and 45 mm to 50 mm; and sterilizing resulting Broussonetia papyrifera bark fibers at 70 °C to 80 °C for 1 h;
S112, placing the 100 parts of the deionized water into a stainless steel container, and adding the 2.8 parts to 12.5 parts of the cellulase, the 1.4 parts to 3.7 parts of the acid protease, and the 0.7 part to 3.7 parts of the pectinase to the stainless steel container; heating the stainless steel container on a heating plate to a temperature of 45 °C to 50 °C, and holding the temperature of 45 °C to 50 °C for 2 min to 5 min to produce a bio-composite enzyme solution; and keeping the bio-composite enzyme solution at 45 °C to 50 °C, wherein during the heating, gentle stirring is conducted with a stirring rod until three enzymes are completely dissolved;
S113, adding sterilized Broussonetia papyrifera bark fibers obtained in the S111 to the bio-composite enzyme solution obtained in the S112, and further heating the stainless steel container on the heating plate to the temperature of 45 °C to 50 °C; under heating, immersing an ultrasonic generator probe in a resulting suspension, conducting an ultrasonic treatment for 2 min to 3 min with an ultrasonic power of 100 W to 150 W and an ultrasonic frequency of 50 kHz to 60 kHz, and allowing a resulting system to stand for 20 min to 30 min; repeating the ultrasonic treatment 8 times to 10 times, with a total treatment duration of 4 h; and after enzymatic hydrolysis is completed, heating to a temperature of 85 °C, and holding the temperature of 85 °C for 10 min to allow enzyme deactivation;
S114, filtering a mixed system obtained in the S113 to produce an enzymatic hydrolysate and a solid residue, and drying the solid residue with hot air at 50 °C to 60 °C until a moisture content is less than or equal to 12% to produce the bioenzymatically hydrolyzed Broussonetia papyrifera bark fibers.

11. The preparation method according to claim 9, wherein in the solid waste-based permeable brick with the heavy metal/saline-alkali barrier and slow-release fertilizer functions for the tree planting pits, the slow-release fertilizer microgel comprises the following components in parts by mass: 2 parts to 5 parts of chitosan, 1 part to 2 parts of a glutaraldehyde crosslinking agent solution, 40 parts to 50 parts of a sheep manure fertilizer from an intensive farm, 15 parts to 20 parts of potassium humate, 8 parts to 12 parts of ammonium sulfate, 5 parts to 8 parts of calcium superphosphate, 85 parts to 90 parts of an acetic acid solution, and 30 parts to 40 parts of distilled water; and the chitosan has a particle size of 100 mesh to 200 mesh, a concentration of the glutaraldehyde crosslinking agent solution is 1% to 2%, the potassium humate has a particle size of 100 mesh to 150 mesh, the ammonium sulfate has a particle size of 60 mesh to 100 mesh, the calcium superphosphate has a particle size of 100 mesh to 200 mesh, and a concentration of the acetic acid solution is 1% to 2%.

12. The preparation method according to claim 11, wherein in the solid waste-based permeable brick with the heavy metal/saline-alkali barrier and slow-release fertilizer functions for the tree planting pits, a preparation method of the slow-release fertilizer microgel comprises the following steps:
S121, adding the 40 parts to 50 parts of the sheep manure fertilizer from the intensive farm, the 15 parts to 20 parts of the potassium humate, the 8 parts to 12 parts of the ammonium sulfate, and the 5 parts to 8 parts of the calcium superphosphate to a mixer, and stirring for 3 min to 5 min at 100 r/min to 120 r/min; and adding the 30 parts to 40 parts of the distilled water to a resulting mixed material under stirring until a humidity of the mixed material reaches 30% to 40% to produce a plastic lumpy material with a particle size of 2 mm to 5 mm;
S122, placing the 85 parts to 90 parts of the acetic acid solution into a stainless steel container, and adding the 2 parts to 5 parts of the chitosan; and immersing an ultrasonic generator probe in a resulting solution, and conducting an ultrasonic treatment for 2 min to 3 min with an ultrasonic power of 120 W to 150 W and an ultrasonic frequency of 45 kHz to 60 kHz to make the chitosan fully dissolved and uniformly dispersed and reduce a surface tension of the solution;
S123, slowly pouring the plastic lumpy material prepared in the S121 into a chitosan solution prepared in the S122, and stirring for 5 min to 10 min with a constant-temperature magnetic stirrer at 30 °C to 35 °C and 200 r/min to 300 r/min; under stirring, adding the 1 part to 2 parts of the glutaraldehyde crosslinking agent solution dropwise at a rate of 1 drop/s to 2 drops/s; and after dropwise addition is completed, further stirring at 200 r/min to 300 r/min for 1 min to 2 min, and allowing to stand for 2 h to 3 h, such that the chitosan undergoes crosslinking and curing on a surface of a core material to form a stable coating;
S124, pouring a solution in which the core material is coated obtained in the S123 into a centrifuge tube, centrifuging for 5 min to 8 min in a centrifuge at 3,000 r/min to 4,000 r/min, and discarding a resulting supernatant to produce slow-release fertilizer microgel particles;
S125, placing the solution obtained in the S124 into a lyophilization device, pre-cooling for 10 min to 15 min at −20 °C, and lyophilizing for 5 h to 8 h to produce the slow-release fertilizer microgel.

13. The preparation method according to claim 9, wherein in the solid waste-based permeable brick with the heavy metal/saline-alkali barrier and slow-release fertilizer functions for the tree planting pits, the glutinous rice-based bioadhesive comprises the following components in parts by mass: 10 parts to 15 parts of glutinous rice flour, 0.1 part to 0.2 part of alum, and 10 parts to 20 parts of the water; and the glutinous rice flour has a particle size of 90 mesh to 100 mesh, and the alum has a particle size of 180 mesh to 200 mesh.

14. The preparation method according to claim 13, wherein in the solid waste-based permeable brick with the heavy metal/saline-alkali barrier and slow-release fertilizer functions for the tree planting pits, a preparation method of the glutinous rice-based bioadhesive comprises the following steps:
S131, placing 5 parts to 10 parts of the water into a stainless steel container, and adding the 10 parts to 15 parts of the glutinous rice flour; and heating the stainless steel container on a heating plate to 50 °C to 60 °C, and under heating, gently stirring a mixture with a stirring rod for 3 min to 5 min;
S132, after a pasty mixture is obtained in the S131, adding the 0.1 part to 0.2 part of the alum and remaining water; further heating to 80 °C to 85 °C, and under heating, stirring a mixture with a stirring rod in an identical direction for 8 min to 10 min; and after a fluid gel-like liquid is obtained, stopping the heating, and cooling to 23 °C to 26 °C to produce the glutinous rice-based bioadhesive.

15. The preparation method according to claim 9, wherein in the solid waste-based permeable brick with the heavy metal/saline-alkali barrier and slow-release fertilizer functions for the tree planting pits, the high-calcium sulfur-aluminum system-based multi-phase composite brick binder comprises the following components in parts by mass: 40 parts to 50 parts of acidic slag powder, 25 parts to 30 parts of high-calcium fly ash, 8 parts to 12 parts of metakaolin, 4 parts to 6 parts of desulfurized gypsum, 10 parts to 12 parts of in-situ soil, and 0.1 part to 0.2 part of glycerol; and a preparation method of the high-calcium sulfur-aluminum system-based multi-phase composite brick binder comprises the following steps:
S21, washing the in-situ soil with the water to remove soluble salts, and oven-drying in an oven at 105 °C to 110 °C for 6 h to 8 h;
S22, grinding each raw material with a ball mill until a sieve residue is less than 5% when a ground material is sieved through a 200-mesh sieve;
S23, feeding the 40 parts to 50 parts of acidic slag powder, the 25 parts to 30 parts of high-calcium fly ash, the 8 parts to 12 parts of metakaolin, and the 10 parts to 12 parts of in-situ soil into a mixer, and dry-blending for 15 min to 20 min to make raw material powders thoroughly mixed;
S24, adding the 4 parts to 6 parts of the desulfurized gypsum and the 0.1 part to 0.2 part of the glycerol to a mixed powder obtained in the S23, and grinding until a specific surface area reaches 400 m²/kg to 500 m²/kg to produce the high-calcium sulfur-aluminum system-based multi-phase composite brick binder.

16. The preparation method according to claim 9, wherein in the solid waste-based permeable brick with the heavy metal/saline-alkali barrier and slow-release fertilizer functions for the tree planting pits, the gibbsite-biochar composite material has a particle size of 30 mesh to 40 mesh, and is an aluminum- and silicon-rich porous carbon-based material produced through co-pyrolysis of gibbsite and straw biochar.
